(19) United States
(12) Patent Application Publication
(10) Pub. No.: US 2015/0019468 A1
(43) Pub. Date: Jan. 15, 2015

(54) THERMODYNAMIC COMPUTING

(71) Applicant: KnowmTech, LLC, Albuquerque, NM (US)

(72) Inventors: Alex Nugent, Santa Fe, NM (US); Timothy Molter, Oberstdorf (DE)

(73) Assignee: KnowmTech, LLC

(21) Appl. No.: 14/323,451

(22) Filed: Jul. 3, 2014

Related U.S. Application Data
(60) Provisional application No. 61/844,041, filed on Jul. 9, 2013.

(51) Int. Cl. G06N 3/08; G06N 99/00

(52) U.S. Cl. CPC G06N 3/08; G06N 99/005; G06N 3/088; Y10S 901/46
USPC 706/25; 901/46

(57) ABSTRACT

Methods and systems for thermodynamic computing based on the attractor dynamics of volatile dissipative electronics attempting to maximize circuit power consumption. A general model of memristive devices based on collections of metastable switches, adaptive synaptic weights can be formed from a differential pair of memristors and modified according to anti-hebbian and hebbian plasticity. The arrays of synaptic weights can be employed to build a neural node circuit with attractor states that are shown to be logic functions forming a computationally complete set. By configuring the attractor states of the computational building block in different ways, high-level machine learning functions can be demonstrated for real-world applications.

### CROSS-REFERENCE TO PROVISIONAL APPLICATION

This application claims priority under 35 U.S.C. 119(e) to U.S. Provisional Patent Application Ser. No. 61/844,041, entitled “Thermodynamic Computing,” which was filed on Jul. 9, 2013, the disclosure of which is incorporated herein by reference in its entirety.

### FIELD OF THE INVENTION

Embodiments are generally related to the field of thermodynamic computing and to the attractor dynamics of volatile dissipative electronics attempting to maximize circuit power consumption. Embodiments also relate to AHaH (Anti-Hebbian and Hebbian) plasticity learning applications and hardware and software. Applications additionally relate to memristors.

### BACKGROUND

Modern computing relies heavily on reliable building blocks. If one transistor fails, an entire circuit of millions or even billions of transistors may also fail, provided of course that there is no intrinsic redundancy in the circuit. Furthermore, the longer the parts are used, the more likely that the parts will fail. This paradigm stands in stark contrast to biology, which may tend to forget or ignore significant differences. For example, when a computer is taken for repair, the technician never advises that the computer should be given more exercise. The act of using a biological system can actually repair the system, whereas the act of using a computer only increases its likelihood of failure.

Just as a ball will roll into a depression, an attractor-based system will fall into its attractor states. Perturbations (e.g., damage) will be repaired as the system re-converges to its attractor state. If someone cuts himself or herself, for example, the wound will heal. To bestow this property of self-repair on computing systems, a way to represent the computing structures as attractors must be provided.

Volatility is a defining characteristic of life. Through constant dissipation of free energy, living systems continuously repair their seemingly fragile state. A byproduct of this condition is that living systems are intrinsically adaptive at all scales, from cells to ecosystems. This presents a difficult challenge when attempts are made to simulate such large-scale adaptive networks with modern Von Neumann computing architectures. Each “adaptation” must necessarily reduce to memory-processor communication as the state variables are modified. The energy consumed in shuttling information back and forth grows in line with the number of state variables that must be continuously modified. For large-scale adaptive systems such as the brain, the inefficiencies become very much larger to make simulations impractical.

For example, consider that IBM's recent cat-scale cortical simulation of 1 billion neurons and 10 trillion synapses required 147,456 CPUs, 144 TB of memory, and ran at 1/83rd real time. At a power consumption of 20 W per CPU, this is 2.9 MW. In a perfect scaling, a real-time simulation would consume 83 times more power or 244 MW. At roughly thirty times the size of a cat cortex, a human-scale cortical simulation would reach over 7 GW. The cortex represents a fraction of the total neurons in a brain, neurons represent a fraction of the total cells, and the IBM neuron model was extremely simplified. The number of adaptive variables under constant modification in the IBM simulation is orders of magnitude less than the biological counterpart and yet its power dissipation is orders of magnitude larger. From a practical perspective, the IBM simulation served no functional purpose such as object recognition, robotic control or inference. Arguments could therefore be made that perhaps the problem may be avoided by pursuing a machine learning rather than mimicry approach.

Recent work by Google™ to train networks on YouTube™ image data roughly doubled the accuracy from previous attempts, and has since made its way into commercial products and services such as image searching applications. This result, however, came with an eyebrow raising number. The effort took an array of 16,000 CPU cores working at full capacity for 3 days. The model contained 1 billion connections, which although impressive, pales in comparison to biology. The average human neocortex, for example, contains 150,000 billion connections, and the number of synapses in the neocortex is a fraction of the total number of connections in the brain. At 20 W per core, Google's simulation consumed about 320 kW. Under perfect scaling, a human-scale simulation would have consumed 48 GW.

Another argument to be made is that recent trends in computing favor parallel processors such as GPGPUs and large efficiency increases are possible. Large gains are of course logical, since it stands to reason that even moderate optimizations will eat into the billion fold discrepancy currently faced. Thousand fold increases in power and space efficiencies sounds tremendous, and relatively speaking they are, but they are still off by a factor of at least a million.

In 1936 Alan Turing, best known for his pioneering work in computation and his seminal paper ‘On Computable Numbers’, provided a formal proof that a machine could be constructed capable of performing any conceivable mathematical computations if it were representable as an algorithm. This has exploded and evolved to become the computing industry of today. In addition to the work leading to the digital computer, Alan Turing anticipated connectionism and neuron-like computing. In 1968, Turing described a machine composed of artificial neurons connected in any pattern with modifier devices. Modifier devices could be configured to pass or destroy a signal, and the neurons were composed of NAND gates that Turing chose because any other logic function can be created from them.

In 1944 physicist Erwin Schrödinger published the book ‘What is Life?’ based on a series of public lectures delivered at Trinity College in Dublin. Schrödinger asked the question: “How can the events in space and time which take place within the spatial boundary of a living organism be accounted for by physics and chemistry?” Schrödinger described an ‘aperiodic crystal’ that predicted the working of DNA, yet to be discovered, as well as the concept of ‘negentropy’ being the entropy of a living system that it exports to keep its own entropy low. In 1949, only one year after Turing wrote ‘Intelligent Machinery’, synaptic plasticity was proposed as a mechanism for learning and memory by Donald Hebb, who famously postulated that “When an axon of cell A is near enough to excite B and repeatedly or persistently takes part in firing it, some growth process or metabolic change takes place in one or both cells such that A's efficiency, as one of the cells firing B, is increased”. Ten years later in 1958 Frank Rosenblatt defined the theoretical basis of connectionism and simulated the Perceptron, leading to some initial excitement in the field.

In 1953, Horace Barlow discovered neurons in the frog brain fired in response to specific visual stimuli. This was a precursor to the experiments of Hubel and Wiesel who demonstrated in 1959, the existence of neurons in the primary visual cortex of the cat selectively responsive to edges at specific orientations. This led to the theory of receptive fields where cells at one level of organization are formed from inputs at cells in a lower level of organization.

In 1960, Bernard Widrow and Ted Hoff developed ADALINE, which was a physical device that used electrochemical plating of carbon rods to emulate the synaptic elements, which they referred to as “memristors”. This work represents the first integration of memristive-like elements with electronic feedback to emulate a learning system.

In 1969 the excitement with perceptrons was tampered by the work of Marvin Minsky and Seymour Papert, who analyzed some of the properties of perceptrons and illustrated how they could not compute the XOR function using only local neurons. The reaction to Minsky and Papert diverted attention away from connection networks until the emergence of a number of new ideas, including Hopefield networks in 1982, back propagation of error in 1986, Adaptive Resonance Theory in 1987, and many other permutations. The wave of excitement in neural networks began to fade as the key problem of generalization versus memorization became better appreciated and the computing revolution took off.

In 1971, Leon Chua postulated on the basis of symmetry arguments the existence of fourth class of two-terminal electronic device element called a memristor, where the resistance of the device depends on the integral of the input applied to the terminals. The term “memristor” derives from the contraction of the words ‘memory resistor’.

Very-large-scale integration (VLSI) pioneer Carver Mead published with Lynn Conway the landmark text ‘Introduction to VLSI Systems’ in 1980. Mead teamed with John Hopfield and Richard Feynman to study how animal brains compute. This worked help to catalyze the fields of Neural Networks (Hopfield), Neuromorphic Engineering (Mead) and Physics of Computation (Feynman). Mead created the world's first neural-inspired chips including an artificial retina and cochlea, which was documented in his book ‘Analog VLSI’, and ‘Neural Systems’, published in 1989.

Beinenstock, Cooper and Munro (BCM) published a theory of synaptic modification in 1982, now known as the BCM plasticity rule, which attempts to account for experiments measuring the selectivity of neurons in primary sensory cortex and its dependency on neuronal input. When presented with data from natural images, the BCM rule converges to selective oriented receptive fields. This provides compelling evidence that the same mechanisms are at work in cortex, as validated by the experiments of Hubel and Wiesel. In 1989 Horace Barlow reasoned that such selective response should emerge from an unsupervised learning algorithm that attempts to find a factorial code of independent features. Anthony Bell and Terrence Sejnowki extended this work in 1997 to show that the independent components of natural scenes are edge filters. This provided a concrete mathematical statement on neural plasticity: Neurons modify their synaptic weight to extract independent components. Building a mathematical foundation of neural plasticity, Erkki Oja and collaborators derived a number of plasticity rules by specifying statistical properties of the neuron's output distribution, leading to, for example, principle and independent component analysis.

At roughly the same time, the theory of support vector maximization emerged from earlier work on statistical learning theory from Vapnik and Chervonenkis and has become a generally accepted solution to the generalization versus memorization problem in classifiers.

In 2004 Nugent et al. showed how the Anti-Hebbian and Hebbian (AHaH) plasticity rule could be derived via the minimization of a kurtosis objective function and used as the basis of self-organized fault tolerance in support vector machine network classifiers, making the connection that margin maximization coincides with independent component analysis and neural plasticity. In 2006, Nugent first detailed how to implement the AHaH plasticity rule in memristive circuitry and demonstrated that the AHaH attractor states could be used to configure a universal reconfigurable logic gate.

In 2008, HP Laboratories announced the production of the fourth elemental two-terminal electronic device, the memristor. In the same year, Defense Advanced Research Projects Agency (DARPA) Program manager Todd Hylton and advisor Alex Nugent launched the Systems of Neuromorphic Adaptive Plastic Scalable Electronics (SyNAPSE) program with the goal of demonstrating large-scale adaptive learning in integrated electronics at biological scale and power, kicking off an explosion of interest in memristive devices, their connection to biological synapses, and use in alternative computing architectures.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for thermodynamic computing applications, hardware, and/or software.

It is another aspect of the disclosed embodiments to provide for thermodynamic computing based on the attractor dynamics of volatile dissipative electronics attempting to maximize circuit power consumption.

It is another aspect of the disclosed embodiments to provide for system and method for thermodynamic computing in which the Anti-Hebbian and Hebbian (AHaH) plasticity rule leads to attractor states in the synaptic weights.

The aforementioned aspects and other objectives and advantages can now be achieved as described herein. A method and system for thermodynamic computing based on the attractor dynamics of volatile dissipative electronics attempting to maximize circuit power consumption is disclosed. With a general model of memristive devices based on collections of metastable switches, adaptive synaptic weights are formed from a differential pair of memristors and modified according to anti-hebbian and hebbian plasticity. The arrays of synaptic weights are used to build a neural node circuit with attractor states that are shown to be logic functions forming a computationally complete set. By configuring the attractor states of the computational building block in different ways, high-level machine learning functions are demonstrated including unsupervised clustering, supervised and unsupervised classification, complex signal prediction, unsupervised robotic actuation and combinatorial optimization of procedures, including all key capabilities of biological nervous systems and modern machine learning algorithms with real-world application.

In the disclosed embodiments, thermodynamic computing applications can be implemented in which the Anti-Hebbian and Hebbian (AHaH) plasticity rule leads to attractor states in the synaptic weights. The AHaH attractor states are computationally complete logic functions and can hence be used for universal computation. The attractor states further maximize the margin between opposing data distributions and consequently can be used to accomplish a wide range of useful tasks such as pattern recognition, clustering, combinatorial optimization, signal prediction, robotic actuation and more. Further, AHaH nodes can be constructed from volatile memristive circuits and thus form a physical substrate from which a new form of computing may be derived.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic diagram of attractor states of a two-input AHaH Node, in accordance with the disclosed embodiments;

FIG. 2A illustrates a schematic diagram of universal reconfigurable logic, in accordance with the disclosed embodiments;

FIG. 2B illustrates a schematic diagram of universal reconfigurable logic showing the configuration of attractor states of the AHaH Nodes, in accordance with the disclosed embodiments;

FIG. 3 illustrates a schematic diagram showing states of a Metastable Switch (MSS), in accordance with the disclosed embodiments;

FIG. 4 illustrates a schematic diagram of a differential pair of memristors forming a synapse, in accordance with the disclosed embodiments;

FIG. 5 illustrates a 2-1 two-phase circuit diagram of a AHaH, in accordance with the disclosed embodiments;

FIG. 6 illustrates a circuit diagram showing circuit voltages across memristors during the read and write cycles, in accordance with the disclosed embodiments;

FIG. 7 illustrates a graph showing Correlation between MSS model and Ag-Chalcogenide memristor, in accordance with the disclosed embodiments;

FIG. 8 illustrates a schematic diagram of an unsupervised robotic arm challenge, in accordance with the disclosed embodiments;

FIGS. 9A-9B illustrate graphs of functional and circuit AHaH reconstructed from simulations, in accordance with the disclosed embodiments;

FIG. 10 illustrates a graph showing justification of constant W⁺, the weight conjugate, in accordance with the disclosed embodiments;

FIGS. 11A-11B illustrate graphs of functional and circuit Attractor states of two-input AHaH Node under the three-pattern input, in accordance with the disclosed embodiments;

FIG. 12A illustrates a graph showing spike logic functions for AHaH Node with Logic attractor state occupation frequency after 5000 time steps for both functional model and circuit model, in accordance with the disclosed embodiments;

FIG. 12B illustrates a graph in which the logic function is stable over time for both functional model and circuit model, indicating stable attractor dynamics, in accordance with the disclosed embodiments;

FIGS. 13A-13B illustrate graphs showing functional and circuit simulation results of an AHaH clusterer formed of twenty AHaH Nodes, in accordance with the disclosed embodiments;

FIGS. 14A-14C illustrate graphs showing Gaussian, non-Gaussian, and random Gaussian size and placement of two-dimensional spatial clustering demonstrations, in accordance with the disclosed embodiments;

FIGS. 15A-15F illustrate graphs showing classification benchmarks results of Reuters-21578, Census Income, breast cancer, breast cancer repeated using AHaH model, MNIST and individual F1 classification scores, in accordance with the disclosed embodiments;

FIG. 16 illustrates a graph showing semi-supervised operation of the AHaH classifier, in accordance with the disclosed embodiments;

FIG. 17 illustrates a graph showing complex signal prediction with the AHaH classifier, in accordance with the disclosed embodiments;

FIG. 18 illustrates a bar diagram showing unsupervised robotic arm challenge, in accordance with the disclosed embodiments;

FIG. 19A illustrates a graph showing the distance between the 64 cities versus the convergences time for the AHaH-based and random-based strike search, in accordance with the disclosed embodiments; and

FIGS. 19B-19C illustrate graphs of 64-City traveling salesman experiment depicting lower learning rates lead to better solutions and higher learning rates decrease convergence time, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

A neuron is a specialized type of cell making up the nervous system of most animals. Each neuron can be thought of as a device having a number of inputs (dendrites) and a single output (axon). Neurons connect to each other via plastic connections (synapses) to form networks. The inputs xᵢ in a linear neuron model can be thought of as the active inputs from other neurons that are impinging upon the neuron's synapses. The weights wᵢ can be thought of as the strength of the synapses. The larger wᵢ, the more xᵢ affects the neuron's output.

For the linear mathematical model, each input xᵢ is multiplied by a corresponding weight wᵢ and these values are summed together to form the output y. The output of the neuron is given as a function of the inputs and weights by the equation:

$$y = {\sum }_{i = 0}^{N} {x}_{i} {w}_{i} \qquad Eq . ( 1 )$$

Mathematically speaking a neuron is a hyper plane in N dimensions and it acts to separate input patterns into positive and negative post-synaptic activities. The weights of a neuron may change according to a plasticity rule:

Δwᵢ=xᵢf(y) Eq. (2)

where f(y) is a function of the post-synaptic activation. There are many choices for f(y) such as Anti-Hebbian and Hebbian (AHaH) plasticity or the ‘AHaH Rule’. A neuron that operates the AHaH plasticity rule is referred as an ‘AHaH Node’ or sometimes simply a ‘node’.

The AHaH plasticity rule leads to attractor states in the synaptic weights. AHaH attractor states are computationally complete logic functions and can hence be used for universal computation. The attractor states further maximize the margin between opposing data distributions and consequently can be used to accomplish a wide range of useful tasks such as pattern recognition, clustering, combinatorial optimization, signal prediction, robotic actuation and more. AHaH nodes can be built from volatile memristive circuits and thus form a physical substrate from which a new form of computing can be built.

It should be noted that the Hebbian and Anti-Hebbian: Anti-Hebbian and Hebbian (AHaH) learning usage follows from a mathematical generalization of Hebb's famous postulate: “When an axon of cell A is near enough to excite B and repeatedly or persistently takes part in firing it, some growth process or metabolic change takes place in one or both cells such that A's efficiency, as one of the cells firing B, is increased.”

The simplest mathematical formulation of Hebbian learning is Δw∝xy where x and y are the activities of the pre- and post-synaptic neurons and Δw is the change to the synapse (weight) between them. Then identified anti-Hebbian learning as the negative: Δw∝−xy. State is a relative measure, as in ‘X is bigger than Y’ (positive) or ‘Y is bigger than X’ (negative). With this in mind, meaning of Hebbian and Anti-Hebbian is defined as: Hebbian: Any modification to the synaptic weight that increases the probability that the synaptic state will remain the same upon subsequent measurement.

Anti-Hebbian: Any modification to the synaptic weight that reduces the probability that the synaptic state will remain the same upon subsequent measurement.

### AHaH Plasticity as Independent Component Extraction:

Suppose for a second that a black and white digital picture of a paper is taken. By arranging the pixels in proper rows and columns, it would of course be able to perceive the text and understand what is being written. However, the underlying data structure is not letters, its binary (black and white) pixels. By simply taking the array of pixels and arranging them into any other pattern, what was a coherent paper is now an incoherent jumble of bits. The conclusion is that the structure of the information (the letters) is not the same as the information channels that carry the information (the pixels).

A mechanism to extract the underlying building blocks or “letters” or “independent components” of a data stream, irrespective of the number of data channels those components are communicated over is desired. One method to accomplish this task is Independent Component Analysis (ICA). The two broadest mathematical definitions of independence as used in ICA are (1) Minimization of Mutual Information and (2) Maximization of non-Gaussianity. The non-Gaussianity family of ICA algorithms uses negentropy and kurtosis as mathematical objectives. To find a plasticity rule capable of ICA, it is defined a kurtosis objective function over the post-synaptic activation. It is desired to minimize kurtosis, since it is a measure of the ‘peakiness’ of a distribution. The result is ideally the opposite of a peak: a bimodal distribution. That is, a hyperplane that separates the input data into two classes is sought, resulting in two distinct ‘positive’ and ‘negative’ distributions. Using a kurtosis objective function it can be shown that a plasticity rule of the following form emerges:

Δwᵢ=xᵢ(αy−βy³) Eq. (3)

where α and β and are constants. Eq. (3) is one form of the ‘AHaH Rule’. The most important functional characteristic of Eq. (3) is that as the magnitude of the post-synaptic activation grows large the weight update transitions from Hebbian to anti-Hebbian learning.

### AHaH Plasticity as Margin Maximization:

An AHaH node is a hyperplane attempting to bifurcate its input space. Another term for this hyperplane is a decision boundary. Depending on what side of the hyperplane an input vector falls, the node will output either positive or negative and hence will ‘make a decision’. Given a dataset representing two classes of patterns, a decision boundary is used to distinguish one set from the other. There are many decision boundaries to choose from and the question naturally arises as to which one is best. The generally agreed answer to this question is “the one that maximizes the separation (margin) of the two classes”. The idea of ‘maximizing the margin’ is central to Support Vector Machines (SVMs), arguably one of the most successful machine-learning algorithms to be invented. Although it is beyond the scope of this paper to discuss the history and technical details of machine learning classifiers, it is important to understand this one very important fact: The attractor states of the AHaH rule maximize the margin between opposing data distributions and coincide with the maximum-margin solution. For this reason AHaH nodes are exceptionally useful for machine learning tasks such as supervised and unsupervised classification and clustering.

### On the Meaning of Zero in Logic:

A spike code consists of either a spike (1) or no spike (z). However, a ‘z’ in a spike code is not the same as a ‘0’ in binary logic. In digital logic, the state ‘0’ is opposite or complimentary to the state ‘1’ and it can be communicated. One cannot communicate ‘nothing’. For this reason, it is referred to a spike as ‘1’ and no spike as a ‘z’ or ‘floating’ to avoid this confusion. The output of an AHaH Node can be positive or negative and hence possesses a state. These positive and negative output states are identified as logical outputs ‘1’ and ‘0’, respectively. Therefore, when a ‘0’ for the output of an AHaH Node is used, it should be interpreted as ‘negative’ or ‘the opposite of positive’ or a ‘logical 0’. This confusion is avoided by changing the symbols of binary logic to ‘+1’ and ‘−1’ so that ‘0’ means ‘nothing’. But this is not possible, because this will additional confusion.

### Logic:

The simplest possible AHaH Node: one with only two inputs is analyzed. The three possible input patterns are

[x₀,x₁]=[z,1],[1,z],[1,1] Eq. (4).

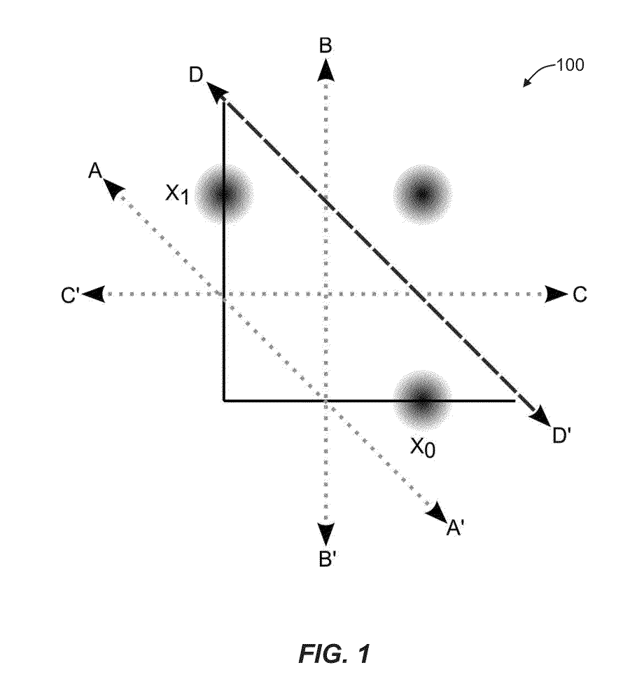

Stable synaptic states will occur when the sum over all weight updates is zero. In this simple case, it is straightforward to derive the stable synaptic weights algebraically. However, it was found that a geometric interpretation of the attractor states to be more conceptually helpful. The AHaH Node's stable decision boundary 100 (solving for y=0) is plotted on the same plot with the data that produced it, as depicted in FIG. 1, where decision boundaries A, B, and C are labeled. Although the D state is achieved in the functional model, it is difficult to achieve in the circuit and for this reason, it is excluded as an available state. The AHaH Rule is a local update rule that is attempting to maximize the margin between opposing data distributions. As the positive distribution pushes the decision boundary away from it (making the weights more positive), the magnitude of the positive updates decreases while the magnitude of the opposing negative updates increases. The net result is that strong attractor states exist when the decision boundary can cleanly separate a data distribution, and the output distribution of y becomes bi-modal.

Referring to the FIG. 1, the AHaH Rule naturally forms decision boundaries that maximize the margin between data distributions (black blobs). This is easily visualized in two dimensions, but it is equally valid for any number of inputs. Attractor states are represented by decision boundaries A, B, C, and D. Each state has a corresponding anti-state: ψ=ψ′. State A is the null state as its occupation is inhibited by the bias. State D has not yet been reliably achieved in circuit simulations.

State A and all higher-order generalization is referred as the null state. The null state occurs when an AHaH Node assigns the same weight value to each synapse and outputs a +1 or −1 for every pattern. The null state is (mostly) useless computationally, and its occupation is inhibited by bias weights.

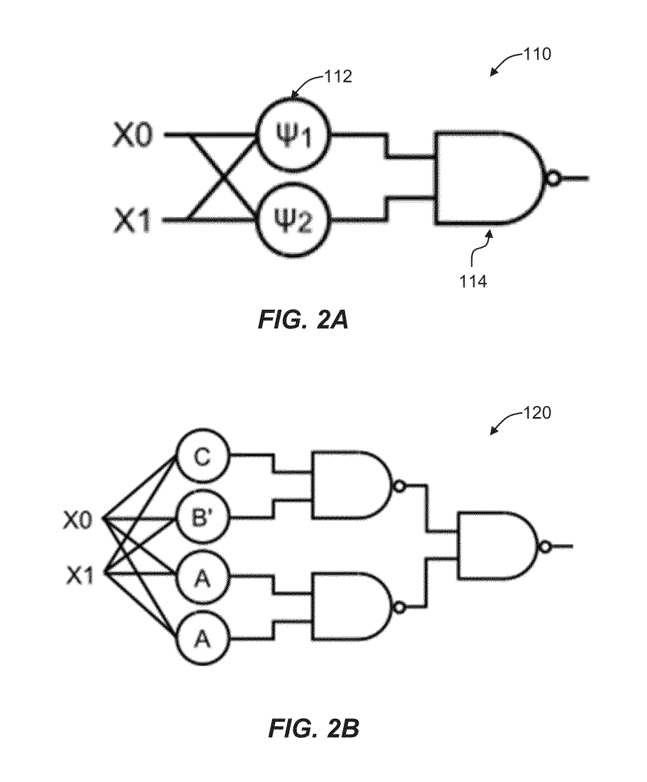

Referring to the FIGS. 2A-2B, formation of universal reconfigurable logic is illustrated. As shown in FIG. 2A, by providing the output of AHaH Nodes to the input of static NAND gates 114, reconfigurable logic function 110 is created by configuring the AHaH Node attractor states ψ₁ 112. Also, shown in FIG. 2B, by configuring the attractor states of the AHaH Nodes, any possible logic function can be configured and universal logic 120 over space of IC states can be performed.

All logic functions can be achieved directly with AHaH attractor states if defined a ‘spike logic’ code, where 0=[1,z] and 1=[z,1], as seen in Table 1.

TABLE 1
Two Channel Spike Logic Patterns

| Logic Pattern | Spike Logic Pattern |
|---|---|
| [0, 0] | [1, z, 1, z] |
| [0, 1] | [1, z, z, 1] |
| [1, 0] | [z, 1, 1, z] |
| [1, 1] | [z, 1, z, 1] |

Digital logic states ‘0’ and ‘1’ across two input lines are converted to a spike code across four input lines. This encoding insures that the number of spikes at any given time is constant.

In disclosed spike logic code, the ‘logical 0’ and ‘logical 1’ state is converted to a spike on one of two lines. If this encoding trick is performed, the ability to attain all logic functions via AHaH attractor states, minus the XOR functions is gained. Also it is well known that the XOR functions can be attained via combinations of other logic gates, for example, the NAND gate as Turing knew. For this reason the AHaH attractor states are provable computationally complete. As any algorithm or procedure can be attained from combinations of logic functions, AHaH Nodes are capable of supporting universal computation and thus a suitable building block from which a new form of computing may be constructed.

### Volatility

To avoid confusion, defined precisely what is meaning of volatility as it relates to a synapse. A synapse is volatile if the act of accessing (reading) the synaptic state damages the state (i.e. anti-Hebbian learning). The act of reading the state increases the uncertainty of the state. This definition connects the act of memory access with the memory itself and as such differs from the common usage in the electronics industry, which usually describes a property (i.e. decay) intrinsic to the device itself. To make definition of volatility clear, it is possible to construct a volatile synapse out of memristors that do not decay in time. In this case, the synaptic state is given as the difference in conductance of a differential pair and the voltage of the read operation moves the differential toward zero.

### Generalized Memristor Model

A simple memristor model that captures the properties of stochasticity and voltage-dependent state modifications can be developed, while containing as few free parameters as possible. The model arises from the notion that memristors can be represented as a collection of conducting channels that switch between states of differing resistance. The channels could be formed from molecular switches, atoms, ions, nanoparticles or more complex composite structures. Modification of device resistance is attained through the application of external voltage that causes the channels to transition between conducting and non-conducting states.

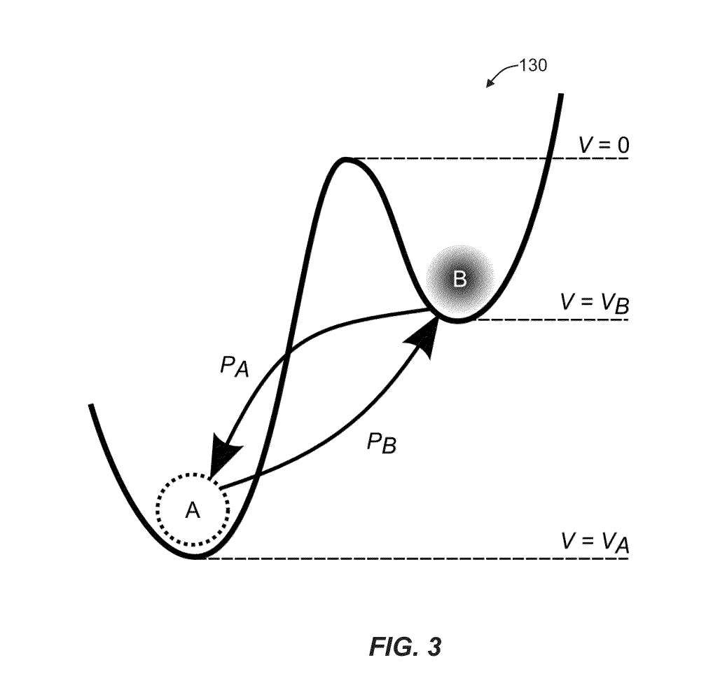

An MSS is an idealized two-state device that switches probabilistically between its two states as a function of applied bias and temperature. A metastable switch (MSS) 130 possesses two states, A and B, separated by a potential energy barrier as shown in FIG. 3. Let the barrier potential be the reference potential V=0. The probability that the MSS will transition from the B state to the A state is given by P_{A}, while the probability that the MSS will transition from the A state to the B state is given by P_{B}. The transition probabilities are modeled as:

$$\begin{matrix}{P}_{A} = α \frac{1}{1 + {e}^{- βγ ( Δ V - {V}_{A} )}} = αΓ ( Δ V , {V}_{A} ) & Eq . ( 5 ) \\ {P}_{B} = α ( 1 - Γ ( Δ V , {V}_{B} ) ) \\ where \\ β = \frac{q}{kT} = {( {V}_{T} )}^{- 1} \cdot {V}_{T} & Eq . ( 6 )\end{matrix}$$

is the thermal voltage and is equal to approximately 26 mV⁻¹ at T=300 K,

$$α = \frac{Δ t}{{t}_{c}}$$

is the ratio of the time step period Δt to the characteristic time scale of the device, t_{c}, ΔV is the voltage across the switch and γ is a dimensionless constant that controls the intrinsic decay rate of the device. P_{A} is defined as the positive-going direction, so that a positive applied voltage increases the chances of occupying the A state. Each state has an intrinsic electrical conductance given by w_{A} and w_{B}. The convention is that w_{B}>w_{A}. A MSS possesses utility in an electrical circuit as a memory or adaptive computational element so long as these conductances differ.

A memristor is modelled as a collection of N metastable switches evolving in discrete time steps Δt. The memristor conductance is given by the sum over each metastable switch:

wₘ=N_{A}w_{A}+N_{B}w_{B}=N_{B}(w_{B}−w_{A})+Nw_{A} Eq. (7)

where N_{A} is the number of MSSs in the A state, N_{B} is the number of MSSs in the B state and N=N_{A}+N_{B}. At each time step, some sub-population of the MSSs in the A state will transition to the B state, while some sub-population in the B state will transition to the A state. The probability that k switches will transition out of a population of n switches is given by the binomial distribution:

$$P ( n , k ) = \frac{n !}{k ! ( n - 1 ) !} {{p}^{k} ( 1 - p )}^{n - k} \qquad Eq . ( 8 )$$

where p is the probability a switch will transition states. As n becomes large we may approximate the binomial distribution with a normal distribution:

$$G ( μ , {σ}^{2} ) = \frac{{e}^{\frac{- {( x - μ )}^{2}}{2 {σ}^{2}}}}{\sqrt{2 π {σ}^{2}}} \qquad Eq . ( 9 )$$

where μ=np and σ²=np(1−p).

The change in conductance of a memristor is modelled as a probabilistic process where the number of MSSs that transition between A and B states is picked from a normal distribution with a center at np and variance np(1−p), and where the state transition probabilities are given by Eq. (5) and Eq. (6).

The update to the memristor conductance is given by the contribution from two random variables picked from two normal distributions:

ΔN_{B}=G(N_{A}P_{A},N_{A}P_{A}(1−P_{A}))−G(N_{B}P_{B},N_{B}P_{B}(1−P_{B})) Eq. (10)

The final update to the conductance of the memristor is then given by:

Δwₘ=ΔN_{B}(w_{B}−w_{A}) Eq. (11)

### Differential Memristors as Synapses

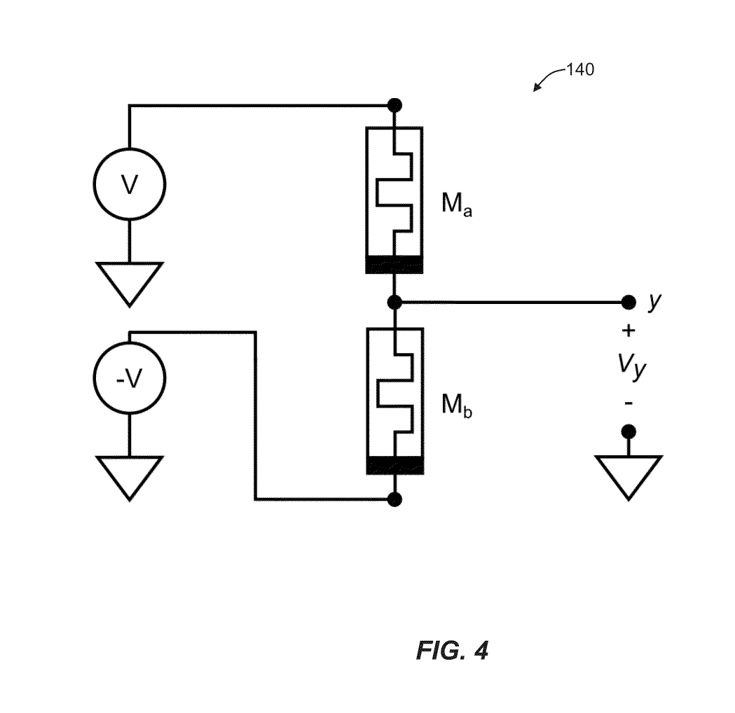

While most neuromorphic computing research has focused on exploiting the synapse-like behavior of a single memristor, it is found that much more useful to implement synaptic weights via a differential pair of memristors. First, a differential pair provides auto-calibration making the synapse resistant to device inhomogeneities. Second, most machine learning models that incorporate synaptic weights treat a weight as possessing both a sign and a magnitude. A solitary memristor cannot achieve this. A synapse 140 formed from a differential pair of memristors is shown in FIG. 4.

A differential pair of memristors is used to form a ‘synapse’ as it allows for it to possess both a sign and magnitude. The bar on the memristor is used to indicate polarity and corresponds to the lower potential end when driving the memristor into a higher conductance state. Mₐ and M_{b} form a voltage divider causing the voltage at y to be some value between V and −V. The memristor pair auto balances itself in the ground state alleviating issues arising from device inhomogeneities.

A differential synapse as described above can potentially be built from traditional transistor technology. One possible approach would be to use a single-transistor synapse. Memristors are more ideal from a couple of perspectives. First, they do not consume real estate in the active portion of the chip and can increase component density. Second, and perhaps more importantly, the adaptation threshold for memristors can be very low compared to floating-gate transistor technology and can thus considerably reduce power consumption. Low adaptation threshold leads to problems of decay and volatility, however, which in turn point toward new methodologies based on self-repairing dissipative electronics.

### AHaH Circuit

There exist numerous memristive circuit designs capable of implementing the AHaH Rule of Eq. 3. The circuits can be broadly categorized by the electrode configuration that forms the synapses as well as how synaptic currents are integrated. For example, synapses formed of one input electrode and two output electrodes are of a ‘1-2’ configuration, two input electrodes and two output electrodes can be termed a ‘2-2’ configuration, and two input and one output electrodes can be termed a ‘2-1’ configuration. Currents can be integrated statically (resistors or memristors) or dynamically (capacitors). Each configuration requires unique circuitry to drive the electrodes so as to achieve AHaH plasticity and multiple driving methods exist. For example, ‘three phase’ refers to the cycles of ‘read’, ‘write’, and ‘decay’. Herein, a ‘2-1’ two-phase circuit configuration is introduced, where the decay operation is combined with the write and read operations for input and bias memristors, respectively.

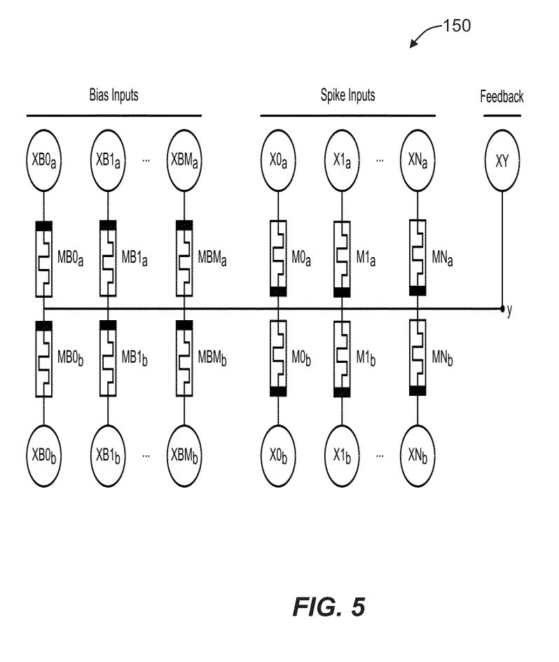

AHaH 2-1 two-phase circuit diagram 150 is illustrated in FIG. 5. The circuit produces an analog voltage signal on the output at y given a spike pattern on its inputs labeled X0, X1, . . . , and XN. The bias inputs XB0, XB1, . . . , and XBM are equivalent to the spike pattern inputs except that they are always active when the spike pattern inputs are active. XY is a voltage source used to implement supervised and unsupervised learning via the AHaH Rule. The polarity of the memristors for the bias synapse(s) is also flipped. The voltage of the output, y, contains both state (positive/negative) and confidence (magnitude) information.

The functional objective of the AHaH circuit diagram 150 shown in FIG. 5 is to produce an analog output at y, given an arbitrary input of length N with k active inputs (spikes) and N-k inactive (floating) inputs. The 2-1 two-phase AHaH Circuit consists of one or more memristive synapses sharing a common electrode y, also referred to as the ‘output’ of the AHaH Node. The spike inputs of the AHaH Circuit, which are assigned to individual spikes, are labeled X0, X1, . . . , and XN. The bias inputs are labeled XB0, XB1, . . . , and XBM. To achieve the AHaH Rule with the circuit shown, a ‘read’ and ‘write’ phase are necessary. Electrodes driven during the read and write phases are indicated with circles and labeled with an X. The voltage applied on the XY electrode is used to drive supervised and unsupervised. The subscript values a and b indicate if the memristor is above or below the y electrode respectively.

During the read phase, a voltage +V and −V is applied across the Xₐ and X_{b} electrodes respectively for all active X inputs matching an incoming spike pattern. The number of bias inputs is chosen ahead of time and they are all activated for every input patter. Inactive inputs are left floating. The combined conductance of the active input and bias lines produce an output voltage on y. This analog output voltage can be digitized to either a logical 1 or a 0 with a voltage comparator if desired, although its magnitude contains useful confidence information, as will be shown.

During the write phase, the voltage on electrode y is set by control circuitry V_{y}^{write}=V s̅g̅n̅(V_{y}^{read}) (unsupervised) or V_{y}^{write}=V s̅g̅n̅(s) (supervised). Furthermore, a voltage −V and +V is applied across the Xₐ and X_{b} electrodes respectively for all active X inputs matching an incoming spike pattern. The polarity switch, relative to the read phase, causes all active memristors to be driven to a less conductive state, counteracting the read phase. If this dynamic counteraction did not take place, the memristors would quickly saturate into their maximally conductive states, rendering the synapses useless.

### AHaH Rule Derivation

During the read phase, the voltage on the y electrode in the circuit 150 shown in FIG. 5 is:

$${V}_{y , read} = V \frac{{\sum }_{i} ( {w}_{a}^{i} - {w}_{b}^{i} )}{{\sum }_{i} ( {w}_{a}^{i} + {w}_{b}^{i} )} \qquad Eq . ( 12 )$$

where the sum is occurring over all spiking and bias inputs and +V and −V are applied across the active Xₐ and X_{b} electrodes respectively.

During the write phase the voltage on electrode y, controlled by voltage source XY, is set to a voltage determined by either a supervisory signal or the anti-sign of the previous read voltage (unsupervised):

$$\begin{matrix}{V}_{y}^{write} = \overline{sgn} ( {V}_{y}^{read} ) \\ = \{ \begin{matrix}+ {VV}_{y}^{read} < 0 \\ 0 {V}_{y}^{read} = 0 \\ - {VV}_{y}^{read} > 0\end{matrix}\end{matrix} \qquad Eq . ( 13 )$$

Furthermore, a voltage −V and +V is applied across active Xₐ and X_{b} electrodes.

As a first-order approximation, the change in conductance of the memristor over a unit of time is represented as proportional to voltage across the memristor and the time over which it is applied:

Δw=λVΔt Eq. (14)

where λ is a constant.

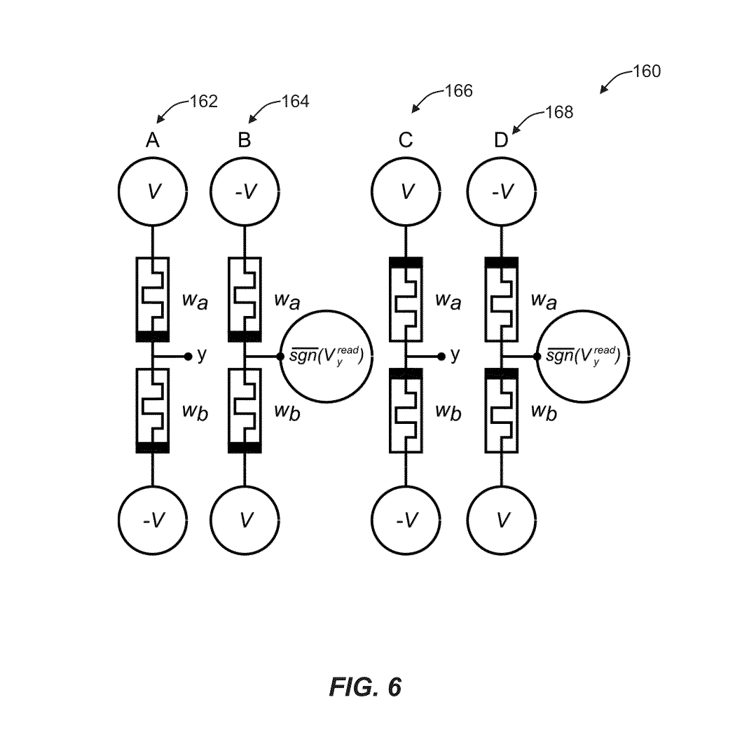

Over the read and write phases, the change to the conductance of the memristors is given in Table 2 and correspond to the circuits 160 of FIG. 6. There are a total of four possibilities because of the two phases and the fact that the polarities of the bias memristors are flipped relative to the spike input memristors. Voltage source XY is set to XY=V s̅g̅n̅(V_{y}^{read}) during the write phase for both spike and bias inputs.

TABLE 2
Memristor conductance updates during the read and write cycle.

| | Input Memristors | | Bias Memristors | |
|---|---|---|---|---|
| | Read | Write | Read | Write |
| | Δt = β | Δt = α | Δt = β | Δt = α |
| | Accumulate | Decay | Decay | Accumulate |
| Δwₐ | βλ(V − V_{y}^{read}) | −αλ(V + V s̅g̅n̅(V_{y}^{read})) | βλ(V_{y}^{read} − V) | αλ(V s̅g̅n̅(V_{y}^{read}) + V) |
| Δwₕ | βλ(V + V_{y}^{read}) | αλ(V s̅g̅n̅(V_{y}^{read}) − V) | −βλ(V + V_{y}^{read}) | αλ(V − V s̅g̅n̅(V_{y}^{read})) |

Both input and bias memristors are updated during one read/write cycle. During the read cycle the input memristors increase in conductance (accumulate) while the bias memristors decrease in conductance (decay). Each contribution to the update in conductance for each pair of the differential weight is given.

Voltages across memristors during the read and write cycles in the circuit 160 is shown FIG. 6. The reference numerals 162 and 164 refer voltages during read and write periods across spike input memristors respectively. The reference numerals 166 and 168 refer voltages during read and write periods across bias memristors.

The terms in Table 1 can be expanded to show the total update to the input memristors over the read and write cycle:

Δwₐ=βλV−βλV_{y}^{read}−αλV−αλV s̅g̅n̅(V_{y}^{read})

Δw_{b}=βλV+βλV_{y}^{read}+αλV s̅g̅n̅(V_{y}^{read})−αλV

Δw=Δwₐ−Δw_{b}=−2βλV_{y}^{read}+2αλV sgn(V_{y}^{read}) Eq. (15)

and likewise for the bias memristors:

Δwₐ=βλV+βλV_{y}^{read}−αλV+αλV s̅g̅n̅(V_{y}^{read})

Δw_{b}=βλV−βλV_{y}^{read}−αλV s̅g̅n̅(V_{y}^{read})+αλV

Δb=Δwₐ−Δw_{b}=2βλV_{y}^{read}−2αλV sgn(V_{y}^{read}) Eq. (16)

Given the differential updates that balance total accumulation and decay, it is assumed that the quantity W⁺ remains constant:

$${W}^{+} = {\sum }_{i} ( {w}_{a}^{i} + {w}_{b}^{i} ) = \frac{1}{k} \qquad Eq . ( 17 )$$

This is an approximation and it is demonstrated below that it is largely justified. However additionally, condition to be enforced that the number of active input spikes is constant. This places an important constraint on how the circuit is used, as further discussed below.

The output voltage during the read phase then reduces to:

V_{y}=kVW⁻ Eq. (18)

where the substitution used is:

$${W}^{-} = {\sum }_{i} ( {w}_{a}^{i} - {w}_{b}^{i} ) \qquad Eq . ( 19 )$$

The quantity VW⁻ is identified as the standard linear sum over active weights of the node as referred in Eq. (1). The change of the i^{th} weight is identified as:

Δwⁱₐ−Δwⁱ_{b}=Δwⁱ=−2βλV_{y}^{read}+2αλV sgn(V_{y}^{read}) Eq. (20)

By absorbing k, λ, and the two constant 2's into the α and β constants, the functional form ‘Model A’ of the AHaH Rule is arrived:

$$y = {\sum }_{i} {w}_{i} + {\sum }_{j = 0}^{M} {b}_{j} \\ Δ {w}_{i} = - β y + α sgn ( y ) + η - ( 1 - δ ) {w}_{i} \\ Δ {b}_{j} = β y - α sgn ( y ) + η - ( 1 - δ ) {b}_{j} \qquad Eq . ( 21 )$$

where bⱼ is the j^{th} bias weight and M is the total number of biases. To shorten the function notation, the substitution is made as V_{y}^{read}→y. Also note that the quantity

$${\sum }_{i} {w}_{i}$$

is intended to denote the sum over the active (spiking) inputs only. The noise variable η (normal Gaussian) and the decay variable δ account for the underlying stochastic nature of the metastable switches that form the memristors.

Model A is an approximation that was derived by making simplifying assumptions that include linearization of the memristor update and the non-saturation of weights at their maximally or minimally conductive states. However, when a weight reaches saturation, |wₐ−w_{b}|→max it becomes resistant to Hebbian modification since the weight differential can no longer be increased, only decreased. This has the desirable effect of inhibiting null state occupation. However, it also means that functional model A is not sufficient to account for these anti-Hebbian forces that grow increasingly stronger as weights near saturation. The result is that model A leads to strange attractor dynamics and weights that can grow without bound, a condition that is clearly unacceptable for a functional model and is not congruent with the circuit.

To account for the growing effect of anti-Hebbian forces a small modification is made to the bias weight update and the result is termed as functional model B:

$$y = {\sum }_{i} {w}_{i} + {\sum }_{j = 0}^{M} {b}_{j} \\ Δ {w}_{i} = - β y + α sgn ( y ) + η - ( 1 - δ ) {w}_{i} . \\ Δ {b}_{j} = - β y + η - ( 1 - δ ) {b}_{j} \\ \qquad Eq . ( 22 )$$

The purpose of a functional model is to capture equivalent function with minimal computational overhead so that large-scale application development is pursued on existing technology without incurring the computational cost of circuit simulations. The use of model B is justified, because simulations prove it is a close functional match to the circuit and it is computationally less expensive than form A.

Finally, in cases where supervision is desired, the sign of the Hebbian feedback may be modulated by an external supervisory signal, s, rather than the evaluation state y:

Δwᵢ=−βy+α sgn(s)+η−(1−δ)wᵢ Eq. (23)

Notice the similarity of Eq. (22) to Eq. (3). Both functional models as well as the form of Eq. (3) converge to functionally similar attractor states. The common characteristic between both forms is a transition from Hebbian to anti-Hebbian learning, as the magnitude of node activation (y) grows large. This transition insures stable attractor states that act to bifurcate data distributions and leads to independent component extraction.

### On the Origins of Algorithms and the 4th Law of Thermodynamics

As Alan Turing was busy laying the foundation for modern computing, one problem troubled him deeply. Where do algorithms come from? The answer, he knew, was biology. Turing spent the last two years of his tragically short life working on mathematical biology and published a paper titled ‘The Chemical Basis of Morphogenesis’ in 1952 see. The problem Turing was trying to tackle was how non-uniformity could arise out of a homogeneous state. Turing was likely struggling with the concept that algorithms represent structure, brains are clearly capable of creating such structure, and brains are ultimately a biological chemical process that emerges from chemical homogeneity. How does a large-scale structure such as an algorithm emerge from the interaction of a homogeneous collection of units?

The disclosed universal logic device composed of AHaH Nodes and NAND gates is remarkably similar to what Turing was envisioning. The question remains, however how can these nodes self-configure their attractor states so that they collectively solve a problem? It is one thing to show that such a network can support any algorithm and it is quite another to show how such a network can come to be without direct programmatic intervention.

To provide a possible answer to this difficult question, it is necessary to review simple differential synapse 140 referred in FIG. 4 under a constant voltage, V. Without decay, both memristors will eventually saturate in their maximally conductive state. If, as is normally the case with any manufactured device, the memristors have a variance in their properties (i.e. saturation conductances), the output voltage, V_{y}, will be random and a function of device fabrication. The situation changes dramatically in the presence of decay. In this case the total accumulation due to the voltage bias is counteracted by decay:

wₐ+λ(V−V_{y})Δt=wₐe^{-Δt/τ}

w_{b}+λ(V_{y}+V)Δt=w_{b}e^{-Δt/τ} Eq. (24)

where wₐ and w_{b} are the conductances of Mₐ and M_{b}, respectively. From these relations it is straightforward to derive the equilibrium output voltage:

$${V}_{y} = V \frac{{w}_{b} - {w}_{a}}{{w}_{a} + {w}_{b}} \qquad Eq . ( 25 )$$

However from Kirchhoffs current law:

$${V}_{y} = V \frac{{w}_{a} - {w}_{b}}{{w}_{a} + {w}_{b}} \qquad Eq . ( 26 )$$

For both of these to be true, the following relation must hold: wₐ=w_{b}.

This is significant because it corresponds to the maximal power dissipation:

$$P = {( V - {V}_{y} )}^{2} {w}_{a} + {( {V}_{y} + V )}^{2} {w}_{b} \\ \begin{matrix}\frac{\partial P}{\partial {w}_{a}} = {V}^{2} - 2 {V}_{y} + {V}_{y}^{2} \\ = 0 \\ = \frac{\partial P}{\partial {w}_{b}} \\ = {V}^{2} + 2 {V}_{y} + {V}_{y}^{2}\end{matrix} \\ {V}_{y} = 0 \qquad Eq . ( 27 )$$

The dissipative equilibrium solution for the output voltage, V_{y}, is also that which maximizes the power dissipation of the circuit. This is not a coincidence. Rather, this is just how nature works. If a system has access to the potential energy necessary for self-configuration, it will select configurations that maximize the energy dissipation rate. This is a postulated 4th law of thermodynamics: “A system will select the path or assembly of paths out of available paths that minimizes the potential or maximizes the entropy at the fastest rate given the constraints.”

The importance of V_{y}=0 is that, via the laws of physics, the spontaneous exploration of logic states. The state of maximal information generation becomes the state of maximal energy dissipation. Recall that to achieve this result, it is to rely on intrinsic memristor decay or to force it though application of a reverse bias. Either way, there is a mechanism for the state of the AHaH Node to configure itself, i.e. without external communication or programming.

In the absence of Hebbian stabilization a unit will descend into a state of ‘maximal logic function reconfiguration’ in search of a new logic function. Once the node has found a logic state that satisfies the problem constraints, Hebbian stabilization returns and locks the node into an attractor state that maximizes the margin between positive and negative node evaluations.

If multiple pathways are allowed, each competing for a limited supply of stabilizing feedback (free energy), there exists conditions necessary for spontaneous optimization. Pathways with more optimal solutions are preferentially stabilized while pathways with less optimal solutions are destabilized and search for new solutions. If a better solution is found, the previously optimal solution is destabilized and the processing repeats.

All experiments are software-based and they involve the simulation of AHaH Nodes in various configurations to perform various adaptive learning tasks. The source code for the experiments is written in the Java programming language and can be obtained from a Git repository linked to from Xeiam LLC's main webpage at http://www.xeiam.com under the AHaH! project. The code used for the experiments is tagged as PLOS_AHAH on the master branch giving a pointer to the exact code used. The specific programs for each experiment are clearly identified at the end of each experiment description in the methods section. Further details about the programs and the relevant program parameters can be found in the source code itself in the form of comments. There are two distinct models used for the simulation experiments: ‘functional’ and ‘circuit’. The simulations based on the functional model use functional model B. The simulations based on the circuit model use ideal electrical circuit components and our MSS model for memristors. Non-circuit behaviors such as parasitic impedances are not included in the circuit simulation experiments. At this stage, it is emphasised that, are attempting to cross the considerable divide between volatile memristors, computing and machine learning by defining a theoretical methodology for computing with attractor states, called ‘Thermodynamic Computing’.

### Metastable Switch Model

A key component of all of the described circuit-based AHaH Node simulations is the MSS model used to model the memristors. In order to avoid unnecessary complexity at this stage, neither to concerned with determining the optimal memristor nor model a large number of existing memristor devices. Aim is shown that the concepts herein are sound and thus decided to set the MSS model parameters to match a memristor device that exists today and for which data is available, even though it might not be the most ideal memristor when it comes time to build AHaH circuits. The Ag-Chalcogenide device can be chosen from primarily because of access to raw device current and voltage data, and it exhibits the desired analog switching profile with low thresholds for adaptation. When it comes time to manufacture AHaH Nodes, an ideal memristor will be chosen taking into consideration such properties as decay rate, on and off conductance, durability, etc. It is likely that other types of memristors will be better candidates and that the best device has not yet been built.

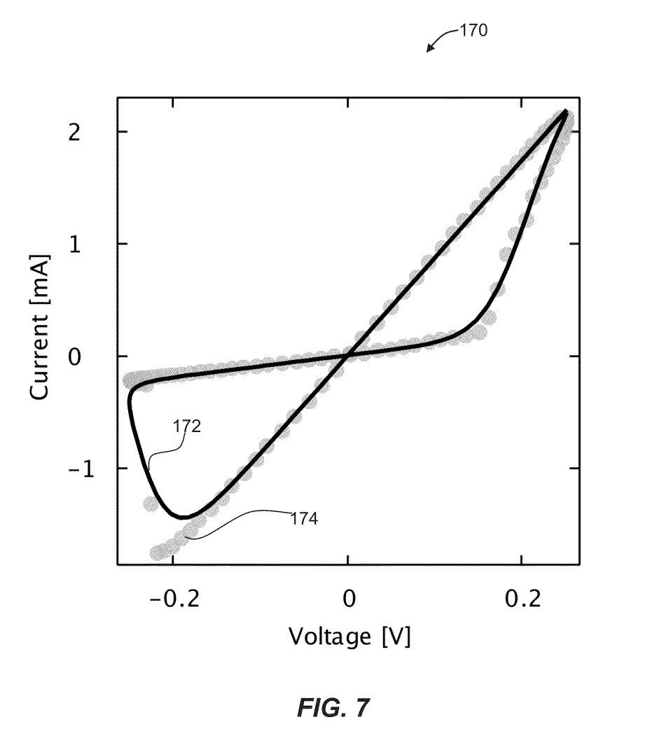

FIG. 7 illustrates a graph 170 showing Correlation between MSS model and Ag-Chalcogenide memristor, in accordance with the disclosed embodiments. By adjusting the free variables in the MSS model and comparing the subsequent current-voltage hysteresis loop to the raw Ag-Chalcogenide I-V data, the matching model parameters were determined. Results are tabulated in Table 3. The conductance of wₐ and w_{b} switch states can be found by dividing the off and on conductance by N, respectively. The parameter γ and the temperature were not available from the experimental data and were set to γ=1 and T=300 K. All subsequent experiments and simulations used these memristor model parameters. The source code for this simulation is in AgChalcogenideHysteresisPlot.java.

TABLE 3
Metastable switch model parameters for Ag-Chalcogenide memristor.

| Time | | On | Off | | | |
|---|---|---|---|---|---|---|
| constant | | conductance | conductance | | | |
| [s] | N | [S] | [S] | VA [V] | VB [V] | γ |
| 0.00032 | 1,000,000 | 0.0087 | 0.00091 | 0.17 | 0.22 | 1 |

The Ag-Chalcogenide memristor from Boise State University was chosen as the first memristor candidate for validating memristor-based AHaH circuits. The parameters in this table were experimentally determined by comparing the current and voltage behavior of the metastable switch model in response to an applied sinusoidal voltage to real I-V data of physical devices.

As shown in FIG. 7, the device simulations using the metastable switch model with fitted parameters is represented by solid lines 172. Current-voltage data taken from a Ag-Chalcogenide memristor device from Boise State University is represented by circles 174. Physical and simulated device current resulted from driving a sinusoidal voltage of 0.25 V amplitude at 100 Hz across the device.

### AHaH Circuit

Circuit simulations were carried out by solving for the voltage differentials over each memristor in each AHaH Node using Kirchhoff's current law during the read and write periods and then updating their values according to the MSS model. The source code for the circuit is available in AHaH21Circuit.java. Parameters for operation of the AHaH Circuit were set as follows: V_{dd}=0.5 V, Vₛₛ=−0.5 V, read period (α)=1 μs, and write period (β)=1 μs. The number of input and bias memristors differed depending on the simulation task, as noted in each section below or in the source code.

### Spike Encoding

All machine-learning applications built from AHaH Nodes have one thing in common: the inputs to the AHaH Nodes take as input a spike pattern. A spike pattern is a vector of integers that specify which synapses in the AHaH Node are co-active. In terms of a circuit, this is a description of what physical input lines are being driven by the supply voltage. All other inputs remain floating (z). Any data source can be converted into a spike code with a spike encoder and many spike encoders exist for various signal sources. As an example, the eye converts electromagnetic radiation into spikes, the ear converts sound waves into spikes, and the skin converts pressure into spikes. Each of these may be considered a spike encoder.

A simple example makes spike encoding clear. Suppose a dataset is available where a list of colors of a person's clothes is associated with the sex of the person. The entire dataset consists of several colors-sex associations. One possible spike encoding for this case could be a mapping of colors to integers. For each person, the colors in the list are mapped to an integer and added to a vector of variable length:

{red,blue,black}→{1,2,5}

{red,yellow,white}→{1,3,4}

{white,black}→{1,5} Eq. (28)

where red maps to 1, blue maps to 2, yellow maps to 3, etc. The spike patterns for this dataset are then {1,2,5}, {1,3,4}, and {1,5}. An AHaH Node would then require five spike inputs in order to accommodate the range of spikes. The integers in the spike pattern set indicate to the AHaH Node which inputs are being driven at the same time. This representation usually means that activity patterns are represented by a small set of active inputs out of a much larger set of potential inputs.

In the case of real-value numbers, a simple recursive method for producing a spike encoding can also conveniently be realized through strictly anti-Hebbian learning via a binary decision tree with AHaH Nodes at each tree node. Starting from the root node and proceeding to the leaf node, the input x is summed with a bias b, y=x+b. Depending on the sign of the result y, it is routed in one direction or another toward the leaf node. The bias is updated according to anti-Hebbian learning, the practical result being a subtraction of an adaptive average.

Δb=−βy Eq. (29)

If we then assigned a unique integer to each node in the decision tree, the path that was taken from the root to the leaf becomes the spike code. This process is an adaptive analog to digital conversion. The source code used to generate this spike encoding is in AHaHA2D.java. This adaptive binning procedure can be extended to sparse-spike encoded patterns if

$$y = {\sum }_{i} {w}_{i} + b \qquad Eq . ( 30 )$$

where wᵢ is sampled randomly from the set {−1,1} with equal frequency.

### AHaH Rule

All experiments and demonstrations disclosed involve the use of AHaH Nodes in various forms and combinations and the functional model governs the functionality of each node. It is therefore important to first and foremost demonstrate that both the functional and circuit implementation of the AHaH Node are equivalent and functioning correctly. The source code for these experiments can be found in AHaHRuleFunctionalApp.java and AHaHRuleCircuitApp.java for both the functional and circuit form respectively. In both applications, a four-input AHaH Node receives the spike patterns from the set {[1,z] and [z,1]}, and the change in the synaptic weights, dwⁱ=wⁱₐ−wⁱ_{b} is measured as a function of the output activation, y. For both the functional and circuit form of the AHaH Node, a bias synapse is included in addition to the normal inputs.

In the derivation of the functional model, the assumption was made that the quantity W⁺ was constant (Refer Eq. (17)). This enabled the treatment of the output voltage as a sum over the input and bias weights. To demonstrate this, the quantities W⁺ and W⁻ (Refer Eq. (17) and Eq. (19)) are plotted for five different four-input AHaH Nodes receiving the spike patterns from the set {[1,z] and [z,1]} for 1100 time steps. The source code for this experiment is in DifferentialWeightApp.java.

### AHaH Logic

A two input AHaH Node will receive three possible spike patterns {[1,z], [z,1] and [1,1]}) and converge to multiple attractor states. Each decision boundary 100 plotted in FIG. 1 represents a state and its anti-state, since two solutions exist for each stable decision boundary. The 6 possible states are labeled A, A′, B, B′, C, and C′. 50 two-input AHaH Nodes with Ag-Chalcogenide memristors were simulated. AHaH Nodes were initialized with random weights picked from a Gaussian distribution with low weight saturation. That is, the memristors were initialized close to their minimally conductive states. Each node was given a stream of 500 inputs randomly picked with equal probability from the set {[1,z], [z,1] and [1,1]}. The source code for this experiment is in a file called TwoInputAttractorsApp.java, and there exists a functional form and a circuit form version.

As stated earlier, the attractor states A, B, and C can be viewed as logic functions. It was earlier demonstrated how NAND gates can be used to make these attractor states computationally complete. It was also described how a spike code consisting of two input lines per channel (2 channels) could be used to achieve completeness directly with AHaH attractor states. To investigate this, 5000 AHaH Nodes were initialized with random weights with zero mean. Each AHaH Node was driven with 1000 spikes randomly selected from the set {[1,z], [z,1] and [1,1]}). Finally, each AHaH Node's logic function was tested, and the distribution of logic functions was measured. The source code for this experiment is in SpikeLogicStateOccupationFrequencyApp.java, and there exists functional form and a circuit form versions.

To demonstrate that the attractor states and hence logic functions are stable over time, the above experiment can be repeated, but the number of time steps can be significantly increased and the logic state of each AHaH recorded at each time step. For this experiment, 100 AHaH Nodes were randomly initialized, and their logic functions were tested over 50,000 time steps. The source code for this experiment is in SpikeLogicFuntionVsTimeApp.java, and there exists functional form and a circuit form versions.

### AHaH Clustering

Clustering is a method of knowledge discovery, which automatically tries to find hidden structure in data in an unsupervised manner. Centroid-based clustering methods like k-means require that the user define the number of cluster centers ahead of time. Density-based methods can be used without pre-defining duster centers, but can fail if the clusters are of various densities. Methods like OPTICS address the problem of variable densities, but introduce the problem that they expect some kind of density drop, leading to arbitrary cluster borders. On datasets consisting of a mixture of known cluster distributions, density-based clustering algorithms are out-performed by distribution-based method such as EM clustering. However, EM clustering assumes that the data is a mixture of a known distribution and as such is not able to model density-based clusters. It is furthermore prone to over-fitting.

An AHaH Node converges to attractor states that cleanly partition its input space by maximizing the margin between opposing data distributions. The set of AHaH attractor states are furthermore computationally complete. These two properties enable a sufficiently large collective of AHaH Nodes to assign unique labels to unique input data distributions while maintaining a high level of tolerance to noise. If a collective of AHaH Nodes are allowed to randomly fall into attractor states, the binary output vector, interpreted as a string, is a label for the input feature. For example, a four node collective with outputs [0,0,0,1] would encode the output string ‘0001’ and, if converted to base-10 integers, be assigned the cluster id ‘1’. The collective node output [1,1,1,1] would encode the output string ‘1111’ and be assigned the cluster id ‘16’. Such a collective is called an AHaH Clusterer.

The total number of possible output labels from the AHaH collective is 2N, where N is the number of AHaH Nodes in the collective. The collective may output the same label for different spike patterns if N is small and/or the number of patterns, F, is high. However, as the number of AHaH Nodes increases, the probability of this occurring drops exponentially. Under the assumption that all attractor states are equally likely, the odds that any two unique spike patterns (F) will be assigned the same binary label goes as:

$$P = \frac{1}{{2}^{N}} + \frac{2}{{2}^{N}} + … + \frac{F}{{2}^{N}} = \frac{{F}^{2} + F}{{2}^{N + 1}} \qquad Eq . ( 31 )$$

For example, given 64 spike patterns and 16 AHaH Nodes, the probability of the collective assigning the same label is 3%. By increasing N to 32 this falls to less than one in a million.

A quantitative metric to characterize the performance of AHaH Clusterer is developed. Given a unique spike pattern F, unique label L (F→L) is desired. This is complicated by the presence of noise, occlusion, and non-stationary data or drift. Failure can occur in two ways. First, if the same underlying pattern is given more than one label, it can be said that the AHaH Clusterer is diverging. The divergence, D is measured, as the inverse of the average labels per pattern. Second, if two different patterns are given the same label, it can be said that it is converging. Convergence, C is measured, as the inverse of the average patterns per label.

Divergence and convergence may be combined to form a composite measure vergence, V:

$$V = \frac{D + C}{2} \qquad Eq . ( 32 )$$

Perfect clusterer extraction will occur with a vergence value of 1. The code used to encapsulate the vergence measurement can be found in the file VergenceEvaluator.java.

To investigate the AHaH Clusterer's performance as measured by vergence metric, the following parameters are swept individually while holding the others constant: learning rate, number of AHaH Nodes, number of noise bits, spike patter length, and number of spike patterns. The applications used to perform the sweeps can be found in the files SweepLeamingRateApp.java, SweepNumAhahNodesApp.java, SweepNumNoiseBits Vs SpikePatternLengthApp.java, SweepSpikePattemLengthApp.java, and SweepNumSpikePattemsApp.java, respectively.

The number of inputs to the AHaH Nodes making up the AHaH Clusterer was 256. Synthetic spike patterns were created with a random spike pattern generator. Given a spike pattern length, the number of inputs available on the AHaH Node, and the number of unique spike patterns, a set of spike patterns was generated. Noise is generated by taking random input lines and activating them or, if the input line is already active, deactivating it. The number of patterns that can be distinguished by the AHaH Clusterer before vergence falls is a function of the input pattern sparsity, number of total patterns, and the pattern noise. Both functional-based and circuit-based AHaH Clusterers were investigated.

While the vergence experiments provide a quantitative measure of the characteristics of the AHaH Clusterer, a program is designed to qualitatively visualize the clustering capabilities. The basic idea is to create several spatial clusters in 2-dimensional space and let the clusterer automatically determine the boundaries between clusters in an unsupervised manner. A k-nearest neighbor algorithm is used to translate the spatial location of cluster points into a spike representation, although other spike encoding methods are of course possible. The AHaH Cluster converges to attractor states that map the unique spike patterns to a unique integer, which is in turn mapped to a unique color. The visualizations give the observer a sense of how tolerant the AHaH Clusterer is to variations in cluster type, size, and temporal stability. The code for the clustering visualization is in ClusteringApp.java. There are several different visualizations including clusters of various sizes, arrangements, and numbers, either remaining in place or moving about in space.

### AHaH Classification

Linear classification is a tool used in the field of machine learning to characterize and apply labels to objects. State of the art approaches to classification include algorithms such as, for example, Decision Trees, Random Forrests, Support Vector Machines (SVM) and Naïve Bayes, and are used in real-world applications such as image recognition, data mining, spam filtering, voice recognition, and fraud detection. AHaH-based linear classifier is different from these techniques mainly in that it is not just another algorithm; it can be realized as a physically adaptive circuit. This presents several competitive advantages; the main one being that such a device would increase the speed and reduce power consumption dramatically while eliminating the problems associated with disk I/O bottlenecks experienced in large-scale data mining applications. In other words, adaptive optimal linear classification can now become a hardware resource.

The AHaH Classifier consists of one or more AHaH Nodes, each node assigned to a classification label and each operating the supervised form of the AHaH Rule of Eq. (23). In cases where a supervisory signal is not available, the unsupervised form of the rule (Eq. (22)) may be used. Higher AHaH Node outputs, y, are interpreted as a higher confidence. There are multiple ways to interpret the output of the classifier depending on the situation. First, one can order all node activations and choose the most positive. This method is ideal when only one label per pattern is needed and an output must always be generated. Second, one can choose all labels that exceed a confidence threshold. This method can be used when multiple labels exist for each input pattern. Finally, only the most positive is chosen if it exceeds a threshold, otherwise nothing is returned. This method can be used when only one label per pattern is needed, but rejection of a pattern is allowed.

To compare the AHaH Classifier to other state of the art classification algorithms, four popular classifier benchmark data sets is chosen: the Breast Cancer Wisconsin (Original), Census Income, MNIST Handwritten Digits, and the Reuters-21578 data sets. The source code for these classification experiments are found in BreastCancerFunctionalApp.java, CensusIncomeApp.java, MnistApp.java, and Reuters21578App.java, respectively.

The classifiers' performance is scored using standard classification metrics: precision, recall, F1, and accuracy. Information on these metrics and how they are used is widely available. The standard training and test sets were used for learning and testing respectively. More information about these benchmark datasets is widely available, and a large amount of classification algorithms have been benchmarked against them including SVM, Naïve Bayes, and decision trees.

To further validate an AHaH Classifier implemented with circuit AHaH Nodes against functional AHaH Nodes, the Breast Cancer Wisconsin (Original) benchmark dataset is chosen. This dataset is relatively small allowing the circuit level simulations to complete in an acceptable time frame. Each sample is either labeled ‘benign’ or ‘malignant’, requiring only one AHaH Node to create the classifier. There were a total of 683 samples. The first 500 were designated as the training set and the last 183 as the test set. Spike encoder for this data set produced a total of 70 unique spikes requiring 70 inputs for this particular classifier. The source code for the circuit form of the Breast Cancer Wisconsin experiment is in BreastCancerCircuitApp.java.

Continuous valued inputs were converted using the adaptive decision-tree method of Eq. (29). Text was converted to a bag-of-words representation where each unique word was representative of a unique spike. MNIST image data was first threshold to produce a spike list of active pixels. The spike list in each 8×8 image patch was converted to a single spike via the method of Eq. (30). The image patch was convolved and pooled over an 8×8 pixel region. The result of this procedure is a list of spikes with moderate translational invariance, which was fed to the AHaH Classifier. The source code for this procedure is available in MnistSpikeEncoder.java.

The AHaH Classifier is capable of unsupervised learning by evoking Eq. (22). If no supervised labels are given but the classifier is able to output labels with high confidence, the output can be assumed to be correct and used as the supervised signal. The result is a continued convergence into the attractor states, which represents a point of maximal margin. This has application in any domain where large volumes of unlabeled data exist, for example, image recognition. By allowing the classifier to process these unlabeled examples, it can continue to improve its performance without supervised labels.

To demonstrate this unsupervised learning capability, the Reuters-21578 dataset is again used. The entire training and test sets were lumped together and the classifier was given the first 25% inputs in a supervised manner. For the remaining 75% of the news articles, the classifier was run in an unsupervised manner. Only when the confidence was 1.0, which indicates high certainty of a correct answer, did the classifier use its own classification as a supervised training signal. The F1 score was recorded after each story for the following most frequent labels: earn, acq, money-fx, grain, crude, trade, interest, ship, wheat, and corn, a common label set used in most benchmarking exercises using this dataset.

### AHaH Signal Prediction

Complex signal prediction involves using the prior history of a signal or group of signals to predict a future state. Signal prediction, also known as signal forecasting, is used in adaptive filters, resource planning, and action selection. Some real-world examples include production estimating, retail inventory planning, inflation prediction, insurance risk assessment, and weather forecasting. Current prediction algorithms include principle component analysis and regression and Kalman filtering.

By posing signal prediction as a multi-label classification problem, complex signals can be learned and predicted using the AHaH Classifier. As a simplified proof of concept exercise to demonstrate this, a complex temporal signal prediction experiment was designed. For each moment of time, the real-valued signal S(t) is converted into a sparse feature representation F(S(t)) using the method of Eq. (29). These features are buffered to form a feature set:

[F(s(t−N)),F(S(t−N+1)), . . . ,F(S(t−1))] Eq. (33)

This feature set is then used to make predictions of the current feature F(S(t)) and the spikes of the current feature are used as supervised labels. After learning, the output prediction may be used in lieu of the actual input and run forward recursively in time. In this way extended predictions about the future are possible. The source code for the experiment is available in ComplexSignalPredictionApp.java. The signal was generated from the summation of five sinusoidal signals with randomly chosen amplitudes, periods, and phases. The experiment ran for a total of 10,000 time steps. During the last 300 time steps, recursive prediction occurred.

### AHaH Motor Control

Motor control is the process by which sensory information about the world and the current state of the body is used to execute actions to generate movement. Stabilizing Hebbian feedback applied to an AHaH Node can occur any time after the Anti-Hebbian read, which opens the interesting possibility of using AHaH Nodes for reinforcement-based learning. Here it is showed that a small collective of AHaH Nodes, an AHaH Motor Controller, can be used in autonomous robotic control. As a proof-of-concept experiment it is used, an AHaH Motor Controller to guide a multi-jointed robotic arm to a target based on a value signal or cost function.

Referring to FIG. 8, a schematic diagram of an unsupervised robotic arm challenge is disclosed. A virtual environment in which an AHaH Motor Controller controls the angles of N connected fixed length rods in order to make contact with a target was created. The arm rests on a plane with its base anchored at the center, and all the joints have 360 degrees of freedom to rotate. New targets are dropped randomly within the robotic arm's reach radius after it captures a target. The robotic arm virtual environment is part of an open-source project called Proprioceptron, also available at http://www.xeiam.com. Proprioceptron builds upon a 3-D gaming library and offers virtual worlds and challenges for testing motor control algorithms. The robotic arm challenge offers 5 levels of difficulty starting with stationary targets and increasing target lateral speed as the level increases.

The robotic arm challenge 180 involves a multi-jointed robotic arm 182 that moves to capture a target. Each joint 184 on the arm has 360 degrees of rotation, and the base joint is anchored to the floor. Using only a value signal relating the distance from the head to target and an AHaH Motor Controller in a closed-loop configuration, the robotic arm 182 autonomously captures stationary and moving targets. New targets are dropped within the arm's reach radius after each capture, and the number of discrete angular joint actuations required for each catch is recorded.

Sensors measure the relative joint angles of each segment of the robot arm as well as the distance from the target ball to each of two ‘eyes’ located on the side of the arm's ‘head’. Sensor measurements are converted into a sparse spiking representation using the method of Eq. (29). A value signal is computed as the inverse distance of the head to the target:

V=1/1+d Eq. (34)

Opposing ‘muscles’ actuate each joint. Each muscle is formed of many ‘fibers’ and a single AHaH Node controls each fiber. The number of discrete angular steps each joint is moved, ΔJ, is given by:

$$Δ J = {\sum }_{i = 0}^{N} [ H ( {y}_{i}^{0} ) - H ( {y}_{i}^{1} ) ] \qquad Eq . ( 35 )$$

where N is the number of muscle fibers, yᵢ⁰ is the post-synaptic activation of the ith AHaH Node controlling the ith muscle fiber of the primary muscle, yᵢ¹ is the post-synaptic activation of the i^{th} AHaH Node controlling the i^{th} muscle fiber of the opposing muscle, and H is the Heaviside step function. The number of discrete angular steps moved in each joint at each time step is then given by the difference in these two values.

Given a movement, it can be said that if a fiber (AHaH Node) acted for or against it. It can be further determined if the movement was good or bad by observing the change in the value signal. If, at a later time, the value increased after a movement, then each fiber responsible for the movement receives rewarding Hebbian feedback. Likewise, if the fiber acted in support of a movement and later the value signal dropped, then the fiber is denied a Hebbian update. As the duration of time between movement and reward increases, so does the difficulty of the problem since many movements can be taken during the interval. Such a reinforcement scheme can be accomplished in a number of ways over a number of timescales and may even be combined. For example, it can be integrated over a number of time scales to determined if the value increased or decreased.

Experimental observation led to constant values of α=0.1 and β=0.5 for the AHaH Rule, although generally good performance was observed for a wide range of values. The choice of these parameters is influenced by the complexity of the problem and the need to learn complex compound sequences, as well as the duration between action (anti-Hebbian) and reward (Hebbian).

The arm's efficiency is measured in catching targets by summing the total number of discrete angular joint actuations from the time the target was placed until capture. As a control, the same challenge was carried out using simple random actuator. The challenge was carried out for both AHaH-controlled and random-controlled robotic arm actuation for different robotic arm lengths ranging from 3 to 21 joints in increments of three. The total joint actuation is the average amount of discrete joint actuation over the 100 captured targets. The source code for this experiment is available in RobotArmApp.java.

### AHaH Combinatorial Optimization

An AHaH Node will descend into a probabilistic output state if the Hebbian feedback is withheld. As the magnitude of the synaptic weight falls closer to zero, the chance that state transitions will occur rises from ˜0% to 50%. This property can be exploited in probabilistic search and optimization tasks. Consider a combinatorial optimization task such as the traveling salesman problem where the city-to-city path is encoded as a binary vector P=[b₀, _{b1}, . . . , b_{N}]. The space of all possible paths can be visualized as the leaves of a binary tree of depth N. The act of constructing a path can be seen as a routing procedure traversing the tree from trunk to leaf. By allowing prior attempted solutions to modify the routing probabilities, an initial uniform routing distribution can collapse into a sub-space of more optimal solutions.

This can be accomplished by utilizing an AHaH Node with a single input as a node within a virtual routing tree. As a route progresses from the trunk to a leaf, each AHaH Node is evaluated for its state and receives the anti-Hebbian update. Should the route result in a solution that is better than the average solution, all nodes along the routing path receive a Hebbian update. By repeating the procedure over and over again, a positive feedback loop is created such that more optimal routes result in higher route probabilities that, in turn, result in more optimal routes. The net effect is a collapse of the route probabilities from the trunk to the leaves as a path is locked in. The process is intuitively similar to the formation of a lighting strike searching for a path to ground and as such it is called as a ‘strike search’.

To evaluate the AHaH Combinatorial Optimizer, functional model B and set α=β in Eq. (22) is used and made it a free parameter, Learning Rate or ‘LRate’ called:

LRate=α=β Eq. (36)

The experiment consists of 200 strike searches, where LRate is set to a value chosen randomly from between 0.00015 and 0.0035 at the start of each trial. The noise variable, η, is picked from a random Gaussian distribution with zero mean and 0.025 variance. After every 10,000 solution attempts, branches with synaptic weight magnitudes less than 0.01 are pruned. A 64-city network is created where each city is directly connected to every other city (as the crow flies) and the city coordinates are picked from a random Gaussian distribution with zero mean and a variance of one. The city path is encoded as a bit sequence such that the first city is encoded with 6 bits, and each successive city with only as many bits needed to resolve the remaining cities such that the second-to-last city required one bit. The value of the solution is the path distance, which is to be minimized. The strike process is terminated when the same solution is generated five successive times, indicating converges. A random search is used as a control, where each new solution attempt is picked from a uniform random distribution. The code for this experiment is in StrikeSearchApp.java.

### AHaH Rule

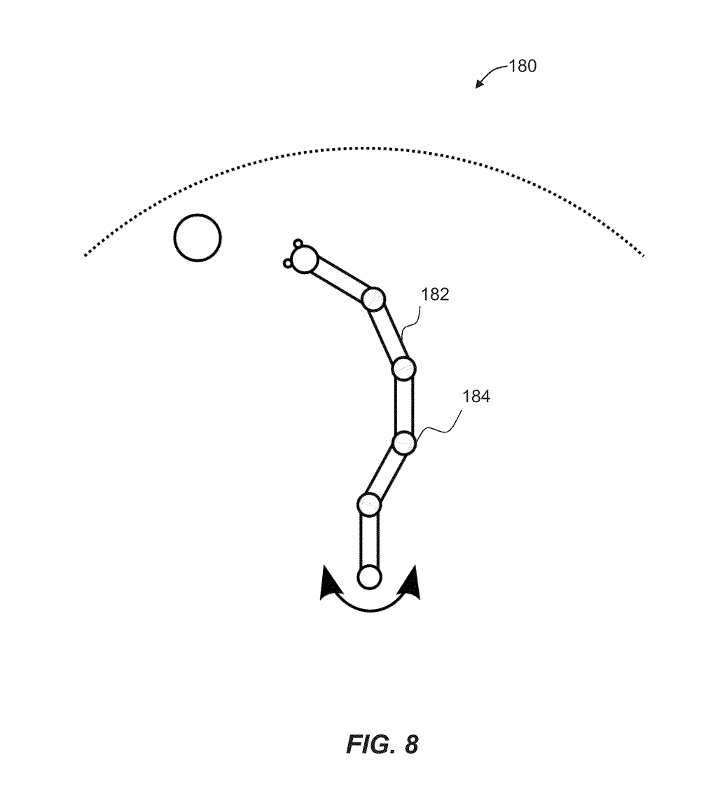

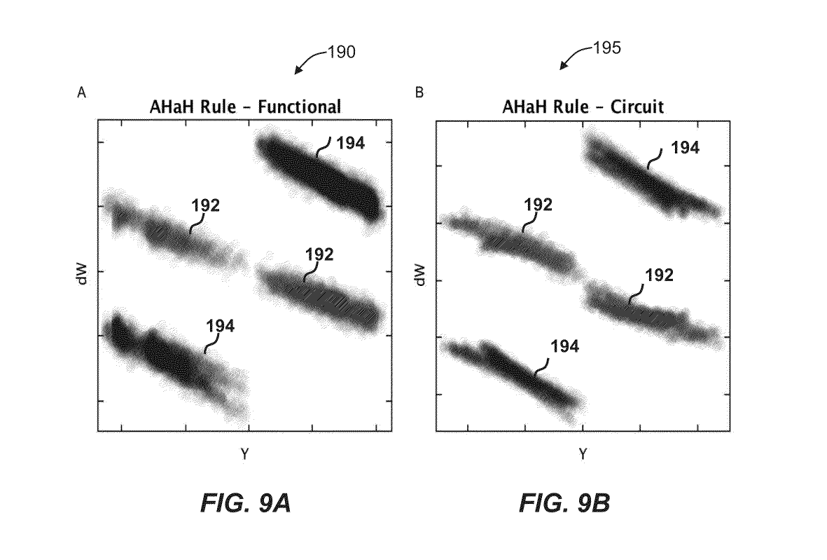

The AHaH Rule reconstructions 190 and 195 for the functional and circuit forms of the AHaH Node are shown in FIGS. 9A and 9B, respectively. In both cases, the AHaH Rule is clearly represented and there is congruence between both forms.

FIG. 9B hides complexity in the circuit that arises from the differential aspect of the weights and their limited dynamic range. Because of this, depending on the saturation state of a weight, the form of weight update may change over time. The AHaH Rule reconstruction of FIG. 9B is thus for a specific weight initialization for a specific time interval.

Referring to FIGS. 9A and 9B, each data point represents the change in a synaptic weight as a function of AHaH Node activation, y. Data points on spike input weights 194 correspond to input synapses and those data points on bias weights 192 corresponds to bias inputs. There is good congruence between the functional 190 and circuit implementations 195 of the AHaH Rule.

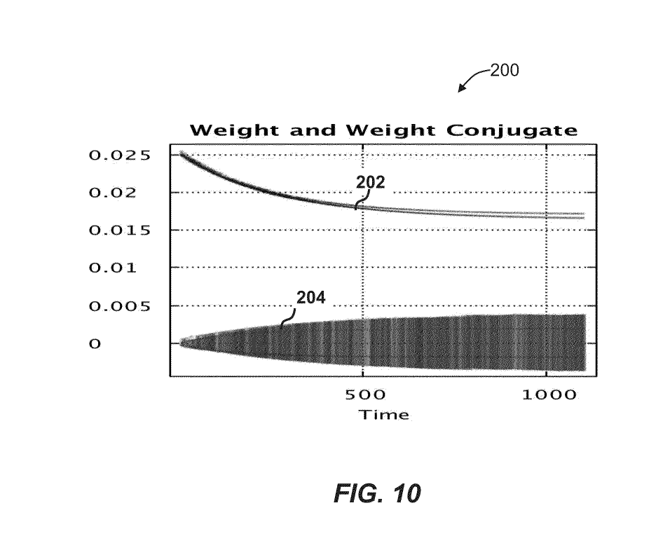

As part of functional model derivation, it is assumed that the quantity W⁺ remained constant and could be factored out of the equation for the output voltage (Eq. (17)). Referring to the FIG. 10, a graph 200 showing the justification treatment of W being a constant. The quantity weight conjugate W⁺202 has a much lower variance that the quantity weight W⁻ 204 over multiple trials, justifying the assumption that W⁺ is a constant factor.

### AHaH Logic

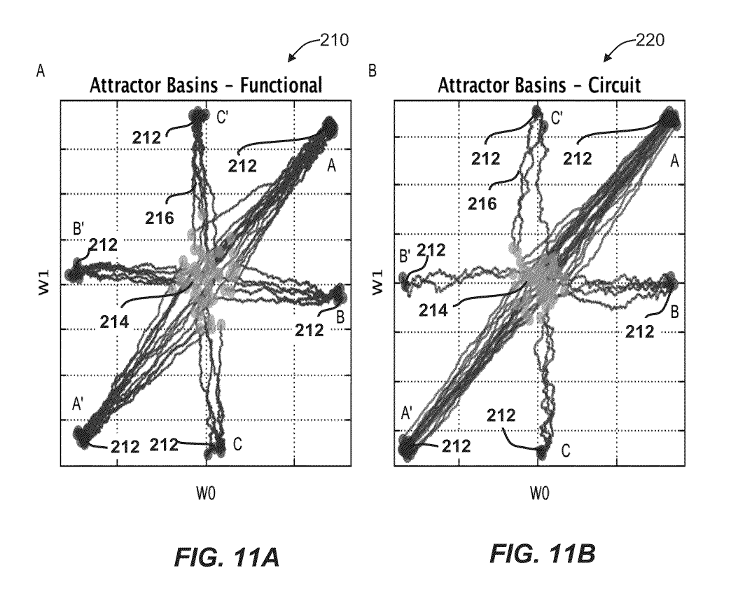

The 2-input AHaH Node receiving 500 consecutive inputs randomly chosen from the set {[1,z], [z,1] and [1,1]}) at 50 different initial synaptic weights evolves into one of the six attractor basins as shown in FIG. 11. Labels A, A′, B, B′, C, and C′ indicate the attractor basins in these weight-space plots and correspond to the equivalent decision boundaries shown in FIG. 1. The same experiment was performed with the functional form and the circuit form of the AHaH Node depicted in FIG. 11A and FIG. 11B, respectively, and close correspondence can be seen.

FIGS. 11A and 11B illustrate graphs 210 and 220 of functional and circuit Attractor states of two-input AHaH Node under the three-pattern input, respectively. The AHaH Rule naturally forms decision boundaries that maximize the margin between data distributions. Weight space plots show the initial weight coordinate 214, the final weight coordinate 212, and the path between 216. Evolution of weights from a random normal initialization to attractor basins can be clearly seen for both the functional model and circuit model.

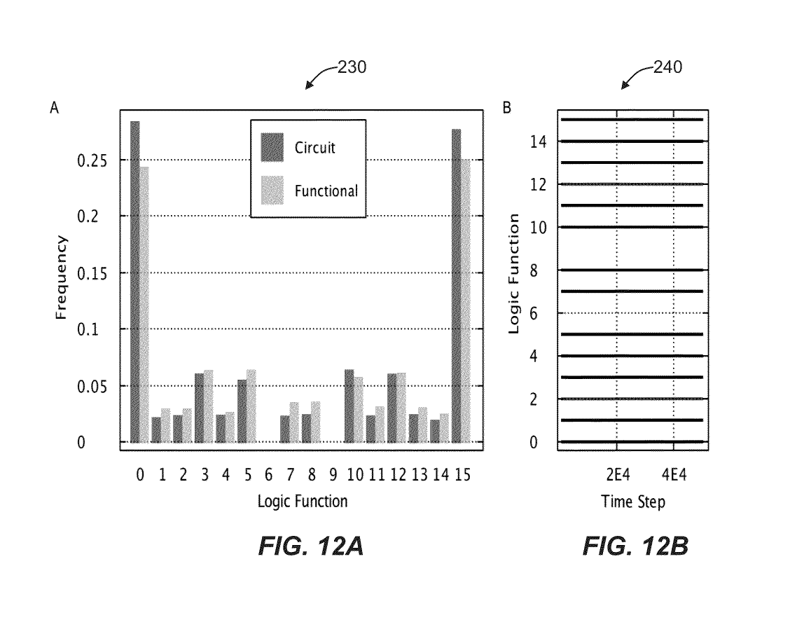

The occupation of logic states of AHaH Nodes receiving the spike logic patterns of Table 2 after being initialized with random synaptic weights are shown in FIG. 12A, as graph 230 for both functional and circuit models. Each logic function was assigned a unique integer value as in Table 4. Experimental results show congruence between the functional form and circuit form simulations. All linear functions are represented by distinct AHaH attractor states. Absent are the expected non-linear XOR functions 6 and 9. These functions are possible through combinations of other logic functions, meaning a multi-stage AHaH Node network is capable of achieving any logic function. Since any algorithm or program can be reduced to successive utilizations of logic gates, the attractor states of AHaH Nodes support universal computational. Logic functions remain stable over time, as indicated by FIG. 12B, as graph 240.

FIG. 12A illustrates the graph 230 showing spike logic functions for AHaH Node with Logic attractor state occupation frequency after 5000 time steps for both functional model and circuit model. FIG. 12B illustrates the graph 240 in which the logic function is stable over time for both functional model and circuit model, indicating stable attractor dynamics.

TABLE 4
Logic Functions.

| | LF | | | | | | | | | | | | | | | |
|---|---|---|---|---|---|---|---|---|---|---|---|---|---|---|---|---|
| SP | 15 | 14 | 13 | 12 | 11 | 10 | 9 | 8 | 7 | 6 | 5 | 4 | 3 | 2 | 1 | 0 |
| [z, 1, z, 1] | 1 | 1 | 1 | 1 | 1 | 1 | 1 | 1 | 0 | 0 | 0 | 0 | 0 | 0 | 0 | 0 |
| [z, 1, 1, z] | 1 | 1 | 1 | 1 | 0 | 0 | 0 | 0 | 1 | 1 | 1 | 1 | 0 | 0 | 0 | 0 |
| [1, z, z, 1] | 1 | 1 | 0 | 0 | 1 | 1 | 0 | 0 | 1 | 1 | 0 | 0 | 1 | 1 | 0 | 0 |
| [1, z, 1, z] | 1 | 0 | 1 | 0 | 1 | 0 | 1 | 0 | 1 | 0 | 1 | 0 | 1 | 0 | 1 | 0 |

All possible logic functions (LF) for spike patterns (SP). AHaH attractor states encompass all logic functions except the XOR and NOT XOR functions (Logic functions 6 and 9).

Logic functions 0 and 15 represent the null state and their occupation is inhibited through the action of the bias. By increasing the number of bias inputs from 1 to 3, the stable attractor states can be collapsed down to 3, 5, 10, and 11. These functions represent the pure independent component states and act to pass or invert each of the two input channels. Although these states are not computationally complete, they can be made so via the use of NAND gates as demonstrated in the earlier section. The advantage of using states 3, 4, 10, and 11 is that they are very stable. The disadvantage is that to rely on external circuitry (i.e. NAND gates) to achieve computational universality.

### AHaH Clustering

The AHaH Clusterer parameter sweep experiment results are summarized in Table 5. While setting the free parameters at their default values and sweeping the parameter under investigation, the range of that parameter that resulted in a vergence value greater than 0.90 was determined. The number of inputs to the clusterer was 256. The performance of the AHaH Clusterer proved to be robust to input pattern noise. For example, the clusterer can achieve perfect performance up to 18% noise under a 100% pattern load. A full pattern load occurs when the number of patterns (16) multiplied by the pattern size (16) is equal to the total number of input line (256 in this case). The clusterer can achieve greater than 90% vergence with up to 44% noise, meaning 7 of the 16 spike input pattern's bits are reassigned random values.

TABLE 5
AHaH Clusterer sweep results.

| | | Number | Number | Spike | Number |
|---|---|---|---|---|---|
| | Learning | Of Ahah | Of Noise | Pattern | Of Spike |
| | Rate | Nodes | Bits | Length | Patterns |
| Default | 0.0005 | 20 | 3 | 16 | 18 |
| Value | | | | | |
| Range | .0002-.0012 | >7 | <=7 | <=36 | <=28 |

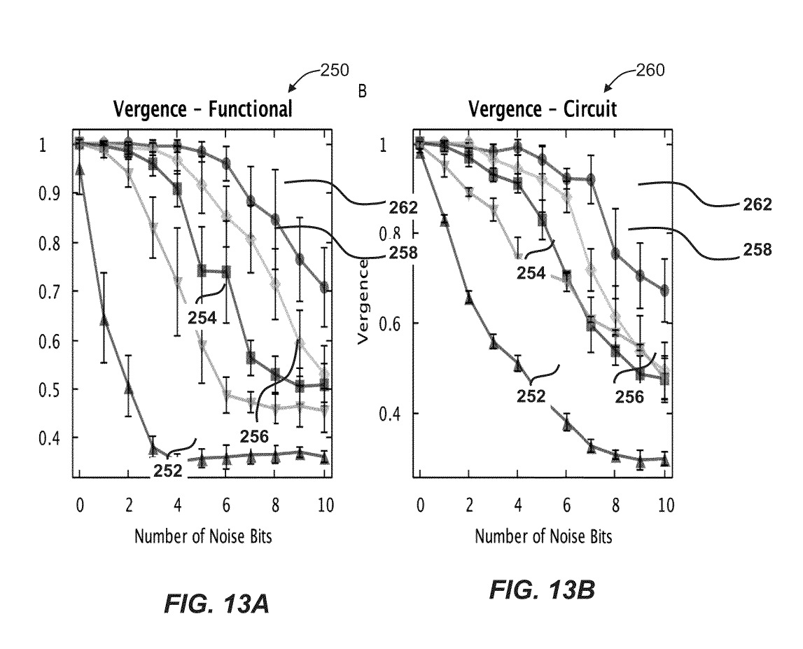

The results shown in FIG. 13 illustrates that the performance as measured by vergence degrades as the number of spike patterns increases. This result is explained by the fact that AHaH plasticity is acting to maximize the margin between data distributions or patterns. As the number of patterns increases, the margin must decrease and hence becomes more susceptible to noise. For example, under a 200% pattern load (32 patterns), vergence falls below 90% after 12.5% noise (2 noise bits). Comparing FIGS. 13A and 13B further demonstrates that circuit and functional models produce similar results. Without noise, the clusterer has impressive capacity and can reliably assign labels to spike patterns with load factors that exceed 400%. While sweeping each parameter and holding the others constant at their default values, the reported range is where the vergence remained greater than 90%.

FIG. 13A and FIG. 13B illustrate graphs 250 and 260 showing functional and circuit simulation results of an AHaH Clusterer formed of twenty AHaH Nodes. Spike patterns were encoded over 16 active input lines from a total 256 lines. The number of noise bits was swept from 1 (6.25%) to 10 (62.5%) while the vergence was measured. The performance is a function of the total number of spike patterns. Values obtained for 100% load curve 262 is equal to 16, values obtained for 125% load curve 258 is equal to 20, value obtained for 150% load curve 256 is equal to 24, value obtained for 200% load curve 254 is equal to 32, and value obtained for 400% load curve 252 is equal to 64.

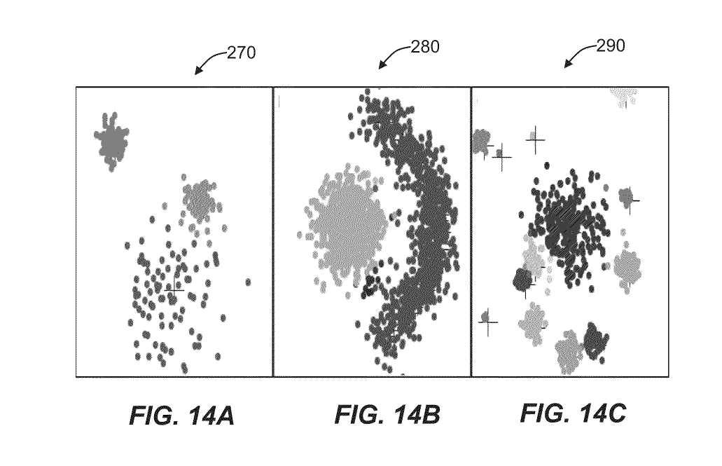

FIG. 14A-14C shows screenshots 270, 280, and 290 of three different 2-dimensional clustering visualizations respectively available from the clustering methods. The AHaH Clusterer performs well for dusters of various sizes and numbers as well as non-Gaussian clusters even though it does not need to know the number of dusters ahead of time or the expected cluster forms, which FIG. 14A shows Gaussian size and placement, FIG. 14B shows non-Gaussian size and placement, and FIG. 14C shows random Gaussian size and placement.

These experiments illustrate some properties of the AHaH Clusterer that set it apart from other methods like K-means and density based clustering algorithms. K-means requires that the user define the number of cluster centers ahead of time. The AHaH Clusterer is able to find the clusters on its own. Density-based methods like DBSCAN can be used without pre-defining duster centers, but fail if the clusters are of various densities. Methods like OPTICS address the problem of variable densities, but introduce the problem that they expect some kind of density drop to detect cluster borders. This leads to arbitrary cluster borders. On datasets consisting of a mixture of Gaussians, these algorithms are nearly always outperformed by methods such as EM clustering. However, EM clustering assumes that the data is a mixture of Gaussians and as such is not able to model density-based clusters.

Disclosed AHaH Clusterer results show that the pairing of a K nearest neighbor spike encoder with the AHaH Clusterer is able to handle the spectrum of cluster types. It is demonstrated that the ability to detect Gaussian and non-Gaussian clusters, clusters of non-equal size, as well as non-stationary clusters. Whereas other methods have intrinsic failure modes for certain types of clusters, disclosed method can apparently handle all cluster types. Although more work must be done to fully compare disclosed methods to existing clustering methods, results thus far indicate that disclosed method offers a genuinely new clustering mechanism with a number of distinct advantages. The most significant advantage is that the AHaH Clusterer can be implemented in physically adaptive AHaH Circuits. In other words, clustering can now become a hardware resource.

### AHaH Classification

AHaH Classifier benchmark scores for the Breast Cancer Wisconsin (Original), Census Income, MNIST Handwritten Digits, and the Reuters-21578 data sets are shown in Table 6 along with results from other published studies using their respective classification methods. Results compare well to published benchmarks and consistently match or exceed SVM performance. This is surprising given the simplicity of the approach, which amounts to simple sparse spike encoding followed by classification with independent AHaH Nodes.

TABLE 6
Benchmark classification results.

| Breast cancer | | | | MNIST handwritten | | | |
|---|---|---|---|---|---|---|---|
| Wisconsin (original) | | Census income | | digits | | Reuters-21578 | |
| AHaH | .997 | AHaH | .86 | AHaH | .98-.99 | AHaH | .92 |
| Rs-SVM | 1.0 | Naïve-Bayes | .86 | Deep convex net | .992 | SVM [Joachims | .92 |
| [Chen | | [frank 2010] | | [Deng 2011] | | 1998] | |
| 2011] | | | | | | | |
| SVM | .972 | NBTree | .859 | Large | .991 | Trees | .88 |
| [Bennett | | [Frank 2010] | | convolutional net | | [Joachims | |
| 1998] | | | | [Ranzato 2007] | | 1998] | |
| C4.5 | .9474 | C4.5 [Frank | .845 | Polynomial SVM | .986 | Naïve-Bayes | .82 |
| [Quinlan | | 2010] | | [Schölkopf 1997] | | [Joachims | |
| 1996] | | | | | | 1998] | |

AHaH Classifier results are for peak F1 score on published test data sets and compare favorably with other methods. Higher scores on the MNIST dataset are possible by increasing the resolution of the spike encoding.

In comparing MNIST results with other methods, it is important to account for data pre-processing and artificial inflation of the training data set through transformations of training samples. The training set is not inflated, results are achievable with only one online training epoch, and both training and test complete on a standard desktop computer processor in a few minutes to less than an hour, depending on the resolution of the spike encoding. The current state of the art achieves a recognition rate of 99.65% and took ‘a few days’ to train on a desktop computer with GPU acceleration. For an interesting perspective, human performance on this task is 97.27%.

The Reuters-21578, Census Income and Breast Cancer datasets cover a range of data types from strings to integers to continuous real-valued signals. The Census Income dataset furthermore contains mixed data types as well as exemplars with missing attributes. In all cases, the AHaH classifier combined with the simple spike encoder of Eq. (29) matched or exceeded state-of-the-art classifiers. This is significant primarily for the reason that both spike encoding and classification functions can be attained via AHaH learning and support the idea that a generic adaptive learning hardware resource is possible.

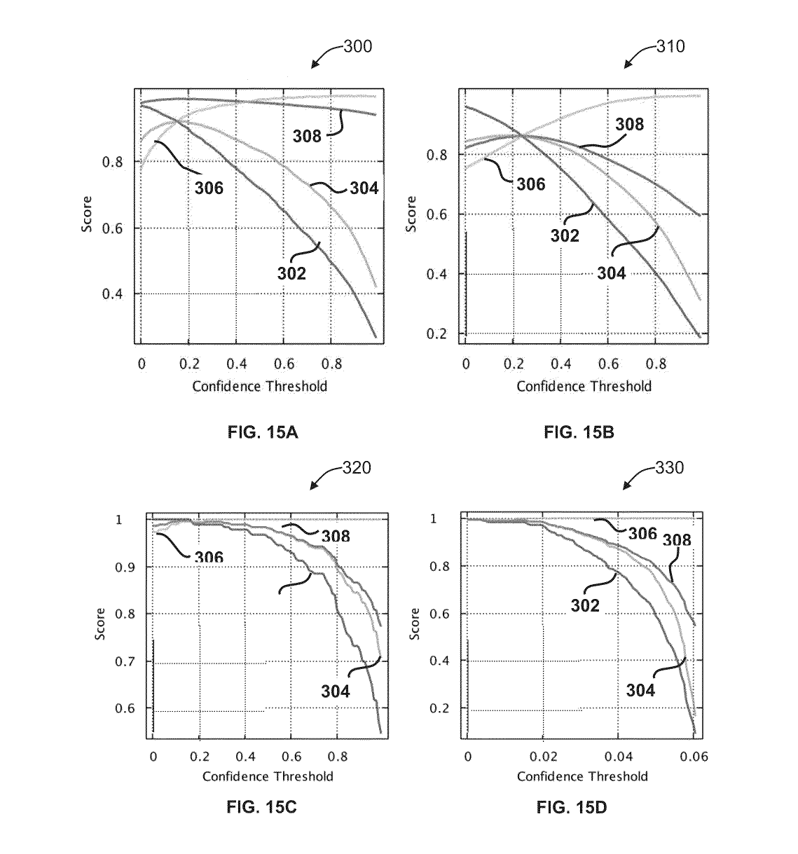

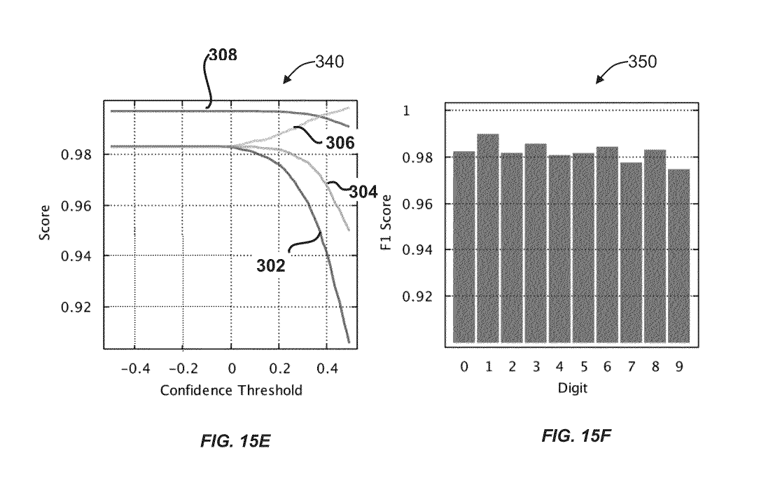

FIGS. 15A-15F provides a more detailed look at the individual classification experiments. Typical for all benchmark data sets, as the confidence threshold of the AHaH Classifier is increased, the precision increases while recall drops (FIGS. 15A-15B). In other words, the classifier makes fewer mistakes at the expense of not being able to answer some queries. The circuit-level simulation yielded a classification score as a function of confidence threshold similar to the functional simulations as shown in FIGS. 15C-15D. The results of the MNIST experiment are shown in FIGS. 15E and 15F. While FIG. 15E shows the average over all digits, FIG. 15F shows the scores of the individual digits.

FIGS. 15A-15F illustrates the classification benchmarks results. Graph 300 relates to Reuters-21578 data set, functional model. Using the top ten most frequent labels associated with the news articles in the Reuters-21578 data set, the AHaH Classifier's accuracy, precision, recall, and F1 score was determined as a function of its confidence threshold. The curve 308 corresponds to accuracy, curve 306 corresponds to precision, curve 304 corresponds to F1, and curve 302 corresponds to recall. As the confidence threshold is increased, the precision increases while recall drops. An optimal confidence threshold can be chosen depending on the desired results, and it can even be dynamically changed. The peak F1 score is 0.92. Graph 310 relates to Census Income functional model. The peak F1 score is 0.86. Graph 320 relates to Breast Cancer functional model. The peak F1 score is 0.997. Graph 330 relates to Breast Cancer repeated but using the circuit AHaH Model rather than the functional model. The peak F1 score and the shape of the curves are similar to functional model results. Graph 340 relates to MNIST functional model. The peak F1 score is 0.98-0.99, depending on the resolution of the spike encoding. Graph 350 relates to the individual F1 classification scores of the hand written digits.

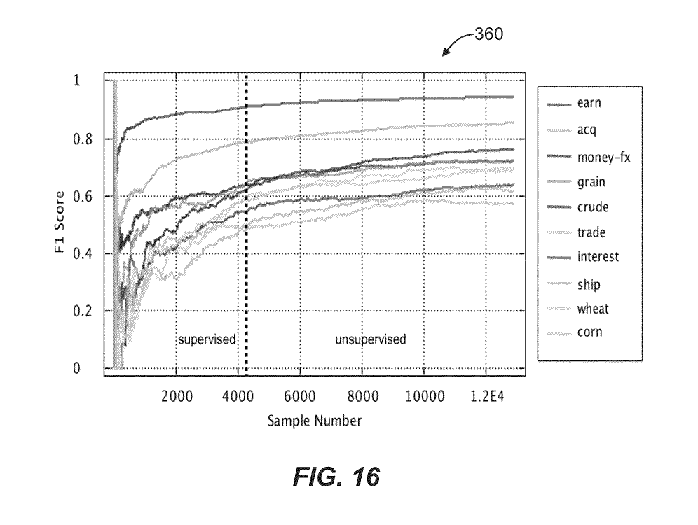

Using the confidence threshold as a guide, the AHaH Classifier can also be used in a semi-supervised mode. Starting in supervised mode and learning over a range of training data, the classifier can then switch to unsupervised mode. In unsupervised mode, Hebbian learning is activated, if the confidence exceeds a value. Results are shown in FIG. 16, which shows continued improved F1 score without supervision. Source code for this experiment is available in Reuters21578SemiSupervisedApp.java.

FIG. 16 shows a graph 360 of the semi-supervised operation of the AHaH Classifier. For the first 25% of the simulation, the AHaH Classifier was operated in supervised mode followed by operation in unsupervised mode. A confidence threshold of 1.0 was set for unsupervised application of a learn signal. The F1 score for the top ten most frequently occurring labels in the Reuters-21578 data set were tracked. These results show that the AHaH Classifier is capable of continuously improving its performance without supervised feedback.

Results to date indicate that the AHaH Classifier is an efficient incremental optimal linear classifier. The December 2006 meeting of the IEEE International Conference on Data Mining produced a list of the top ten algorithms in data mining. The top three algorithms were C4.5, K-Means, and SVM, which are matched or exceeded the performance based on the benchmarks that have been attempted so far. In addition to matching state-of-the-art performance, the AHaH Classifier displays a range of desirable classifier characteristics hinting that it may be a superior general classifier capable of handling a wide range of classification application.

The classifier can be taught in real-time, one example at a time. This is important for large data sets and applications that require constant adaptation such as prediction, anomaly detection, and motor control. The classifier can associate an unlimited number of labels to a pattern, where the addition of a label is simply the addition of another AHaH Node. By allowing the classifier to process unlabeled data, it can get better over time. This has practical implications in any situation where substantial quantities of unlabeled data exist. Through the use of spike encoders, the classifier can handle mixed data types such as discrete or continuous numbers and strings. The classifier is tolerant to missing values, noise, and irrelevant attributes and is very computationally efficient. The most significant advantage, however, is that the circuit can be mapped to physically adaptive hardware. Optimal incremental classification can now become a hardware resource.

### AHaH Signal Prediction

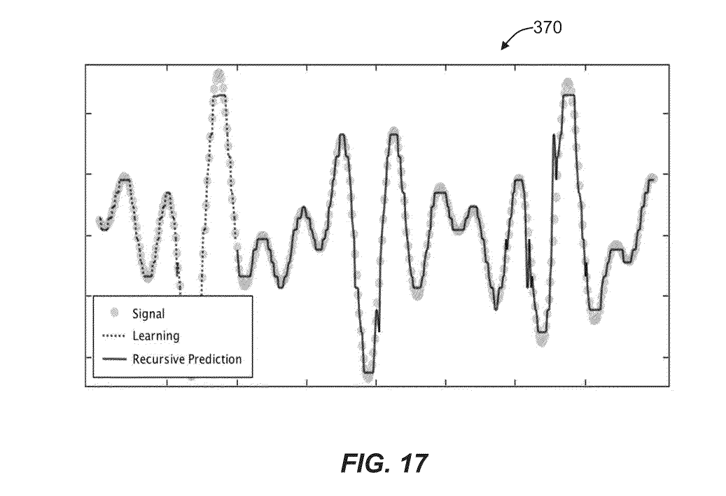

The results of the temporal signal prediction experiment are shown in FIG. 17 as graph 370. The solid line drawn on top of the true signal represents the predictor's accurate prediction of the true complex waveform after a period of supervised learning (mostly not shown). One advantage of the recursive prediction is that the forward-looking time window can be dynamically chosen. Although the predictor was trained to predict only the next time step, the recursive prediction can be carried forward to the desired point in the future for which the prediction should be made, which was 300 time steps in this example. At some point forward though the prediction will degrade if the signal is not deterministic and cyclical. Not all applications require the recursive prediction and a simpler statically set forward-looking time window could be set.

By posing prediction as a multi-label classification problem, the AHaH Classifier can learn complex temporal waveforms and make extended predictions via recursion. Here, the temporal signal (circles) is a summation of five sinusoidal signals with randomly chosen amplitudes, periods, and phases. Towards the end of the experiment (solid line), the predictor loses access to all learning labels as well as the signal itself. Its predictions of the signal at the next time step are only based on its own prediction from the previous time step.

While this temporal signal prediction demonstration is not by any means an exhaustive comparison of AHaH signal prediction to other forecasting algorithms, it demonstrates the utility and flexibility of the AHaH Classifier and provides the first glimpse of using AHaH Nodes in the large application space of signal forecasting. These results also shed light on how AHaH Node supervisory signals could be generated in a completely self-organizing system with zero human intervention. Time is the supervisor and prediction is the Hebbian reward. From the practical perspective, prediction provides the ability to prepare or optimize for the future. It also provides the ability to detect when a system is changing. If a prediction fails to meet with reality, an anomaly has occurred.

### AHaH Motor Control

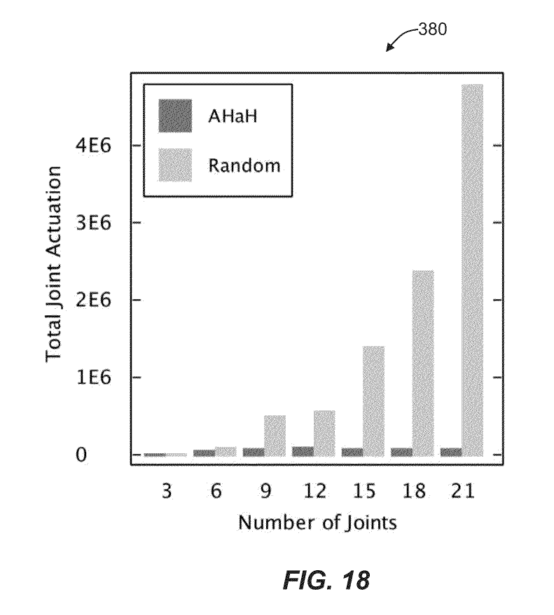

The results of the motorized robotic arm experiment are shown in FIG. 18 as a bar graph 380. The performance of the AHaH-guided robotic arm is compared with a random-guided robotic arm by measuring the average total joint actuation needed to capture 100 moving targets. The results demonstrate that the collective of AHaH Nodes are performing a gradient descent of the value function and can rapidly guide the arm to its target, independent of the number of joints. Videos of AHaH-controlled 3-, 6-, 9-, 12-, and 15-joint robotic arms performing the capture challenge can be viewed in the online Supporting Information section (Videos S5-S9).

The average total joint actuation required for the robot arm to capture the target remains constant as the number of arm joints increases for actuation using the AHaH Motor Controller. For random actuation, the required actuation grows exponentially.

Results show that populations of independent AHaH Nodes can effectively control multiple degrees of freedom so as to ascend (or descend) a value function. This process is spontaneous and results from the emergent behavior of many AHaH Nodes acting as ‘self configuring classifiers’ competing for Hebbian reward. Real-world applications of this effect could of course include actuation of robotic appendages as well as autonomous robots. This is significant primarily because the network can be reduced to physically adaptive circuits and hence can be made to consume very little power and space. This is important because power and space are limiting constraints in mobile platforms.

### AHaH Combinatorial Optimizer

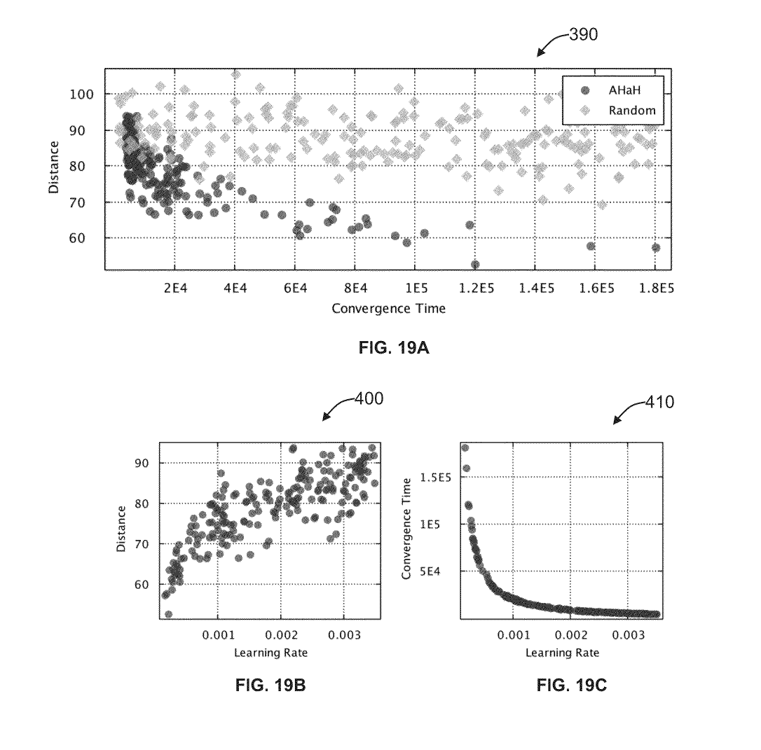

The results of the traveling salesman problem experiment are shown in FIGS. 19A-19C. This experiment demonstrates that an AHaH Combinatorial Optimizer performing a strike search can outperform a strike search backed by a random path chooser referred in FIG. 19A as graph 390. This result demonstrates that the strike is performing a directed search as expected. Trials with higher convergence times resulted from cases where the optimizer was given a relatively lower learning rate. Recall, a lower learning rate allows for a finer-grained search resulting in the longer convergence times. FIG. 19B shows a graph 400 between the learning rate and the solution value (distance), while FIG. 19C shows a graph 410 between the learning rate and the convergence time. Lowering the learning rate causes more evidence to be accumulated before positive-feedback forces selection of a configuration bit.

Referring to FIGS. 19A-19C, by using single-input AHaH Nodes as nodes in a routing tree to perform a strike search, combinatorial optimization problems such as the traveling salesman problem can be solved. Adjusting the learning rate can control the speed and quality of the solution. The distance between the 64 cities versus the convergences time for the AHaH-based and random-based strike search is depicted in FIG. 19A. Lower learning rates lead to better solutions as depicted in FIG. 19B. Higher learning rates decrease convergence time as depicted in FIG. 19C.

A strike evolves in time as bits are sequentially locked in via the positive feedback selection mechanism after a period of evidence accumulation. The lower the learning rate, the more evidence is accumulated before a path is locked in. In this way, a strike search appears to be a relatively generic method to accelerate the search for a procedure.

Using the Traveling Salesman Problem as an example, easily encoded the strike path as a relative procedure for re-ordering a list of cities rather than an absolute ordering. For example, the cities are swapped at indices ‘A’ and ‘B’, then swap the cities at indices ‘C’ and ‘D’, and so on. Furthermore, utilized the strike procedure in a recursive manner. In the case of the traveling salesman problem, assigned ‘lower-level’ strikes to find optimal sub-paths and higher-order strikes to assemble larger paths from the sub-paths. Most generally, if (1) a problem can be represented as a bit configuration, and (2) the configuration can be assigned a value in an efficient manner, then a strike can be used as an ‘adaptive learning hardware resource’ for optimization tasks. The ability to change the convergence times allows dynamic choices to be made in the time available. That is, an instruction could be given to the hardware resource to “find a quick and dirty” solution or alternately to take more time and find a more optimal one.

### Synaptic Power

Power dissipation of each synapse goes as the square of the voltage times the conductance of the memristors: P=V²w. Since each synapse only dissipates energy when it is active (i.e. a spike), and since only a small number of synapses are active at any given time (i.e. a spike pattern), the power dissipated by each synapse is very low. The activity factor, f, accounts for the sparsity of synaptic activation and the duration of read and write phases:

P=f·V²w. Eq. (37)

The duration of a typical read or write phase may last 1 μs or less, although depending on the memristor this can be reduced to 100 ns or less see, Li 2013. For a read/write period of 100 ns, sparsity of activation of 10 spikes/s, voltage V=1V and memristor conductance of w=10⁻⁶ S results in a synaptic power of only 2 pW.

Lowering the voltage will dramatically reduce the power consumption, but not to forget that adaptation must also be available at the lower voltage. This leads to problems of memristor decay, especially at elevated temperatures, since the energy needed to effect a state transition becomes available via thermal fluctuations. Since the AHaH Rule maintains attractor states that act to continuously repair function, Thermodynamic Computing should thrive at low voltages. The same cannot be said of traditional computing.

Demonstrations of utility include results across the field of machine learning, from clustering and classification to prediction, control, and combinatorial optimization. Although it is important to develop specific techniques to address the broad capabilities demonstrated, we wished to convey the idea that the AHaH node is a ‘building block’ from which many ‘higher order’ adaptive algorithms may be built including many not yet conceived of.

As an example, consider results with the AHaH Actuator and Classifier. By using the classifiers confidence estimation as the value function for the AHaH actuator, which in turn controls the viewing position, angle and rotation of an ‘eye’, it should be possible to spontaneously control the gaze of a vision system to find previously trained objects. Alternately, by pairing the AHaH signal prediction with the AHaH combinatorial optimizer, it should be possible to learn to predict a reward signal while simultaneously optimizing actions to attain reward.

Inference from the results is that other capabilities are possible. Anomaly detection, for example, is the inverse of prediction. If a prediction can be made about a temporally dynamic signal then an anomaly signal can be generated should predictions fail to match with reality. Tracking of non-stationary statistics is also a natural by-product of the attractor nature of the AHaH Rule and was slightly touched upon in the 2-D clustering videos, Video S4 in particular. Attractor points of the AHaH Rule are created by the data structure. It follows logically that these same states will shift as the structure of the information changes. It also follows that a system built of components locked in attractor states will spontaneously heal if damaged which is demonstrated in earlier work seen.

An attempt has been made to connect a low-level general statistical model of collections of metastable switches with attractor-based computation and machine learning in a physically realizable circuit. Our aim is to provide a roadmap for others to follow so as to explore and exploit this interesting and potentially useful form of computing. Building this roadmap has required forming two levels of abstractions on the way to realizing the physical circuit: the functional model and the circuit. The purpose of the circuit abstraction is to demonstrate that the core methods are in principle possible and to understand the behavior of the physical system.

The functional model abstraction is necessary to reduce the computational overhead and enable large-scale simulations that tackle real-world problems. Without significant demonstrations of utility, there is little motivation to pursue a new form of computing. Although, working towards a future of physically adaptive AHaH processors, for the short term, necessarily constrained to existing technology. The efficient functional model acts as a bridge between the computational technology of today and the physically adaptive processors of the future.

Ultimate goal is to provide a high-level emulation of a low-level physical ‘adaptive learning hardware resource’ (the AHaH Circuit) in much the same way as modern RAM memory provides a ‘memory resource’ to computing systems. Only when investigated the circuit and functional models and have demonstrated real-world utility should move towards simulation of non-ideal circuits, which include effects such as parasitic impendence, signal delays, and settling times. These details are certainly required for the eventual construction of a neural processing unit (NPU) but limited to show that new type of practical computing is possible that can be realized with existing technologies.

To postulate a new form of computing requires a clear foundation in a physical process. Modern computing has its physical foundation in integrated transistor electronics and the concept of the ‘bit’. Quantum computing has its physical foundation in exploiting the quantum superposition of ‘qubits’. Thermodynamic computing has its foundation in exploiting the desire of nature to maximize the energy dissipation of volatile circuits. The basic unit is called as thermodynamic bit or ‘kTbit’ for short. Rather than this bit being an intrinsic property of the circuit, however, it is a reflection of the underlying independent components of the data stream being processed.

Just as the structure of a river is determined by the flow of water over the streambed, the attractor states and hence logic functions of the AHaH Rule are a function of the information that is being processed and not intrinsic properties of the circuit itself. Just like the structure of a river will disappear when its dissipation rate goes to zero (it turns into a lake), the functions that manifest from the AHaH Rule will also disappear when the dissipation rate goes to zero. The act of using the circuit creates and repairs the circuit and consequently cannot be separated from it. The information of the environment literally becomes the structure of the processor.

Disclosed methods have demonstrated a path from metastable switches to a wide range of machine learning capabilities via an Anti-Hebbian and Hebbian building block. It is shown that memristive devices can arise from metastable switches, how differential synaptic weights may be built of two or more memristors, and how an AHaH Node may be built of arrays of differential synapses. A simple read and write cycle driving an AHaH circuit results in physical devices implementing the AHaH Rule. It is demonstrated that the attractor states of the AHaH Rule can configure computationally complete logic functions and have shown their use in supervised and unsupervised classification, clustering, complex signal prediction, unsupervised robotic arm actuation, and combinatorial optimization. Also demonstrated unsupervised clustering and supervised classification in circuit simulations and have further shown a correspondence between functional and circuit forms of the AHaH Node.

As demonstrated, the AHaH Node may offer us a building block for a new type of computing with likely application in the field of machine learning. Indeed, functions needed to enable perception (clustering, classification), planning (combinatorial optimization, prediction), control (robotic actuation) and generic computation (universal logic) are possible with a simple circuit that does not just tolerate but actually requires volatility.

What is claimed is:

1. A method for thermodynamic computing, comprising:
modifying adaptive synaptic weights according to anti-hebbian and hebbian plasticity, said adaptive synaptic weights configured from a differential pair of memristors;
configuring at least one neural node circuit with attractor states via an array of said adaptive synaptic weights;
configuring a computational building block from at least one neural node circuit with said attractor states; and
obtaining at least one high-level machine learning function from said computational building block for use in machine learning applications.

2. The method of claim 1 wherein said attractor states comprise logic functions that form a computationally complete set.

3. The method of claim 1 wherein said at least one high-level machine learning functions comprises unsupervised clustering.

4. The method of claim 1 wherein said at least one high-level machine learning functions comprises supervised classification.

5. The method of claim 1 wherein said at least one high-level machine learning functions comprises unsupervised classification.

6. The method of claim 1 wherein said at least one high-level machine learning functions comprises complex signal prediction.

7. The method of claim 1 wherein said at least one high-level machine learning functions comprises unsupervised robotic actuation.

8. The method of claim 1 wherein said at least one high-level machine learning functions comprises combinatorial optimization of procedures.
